(19) United States
(12) Patent Application Publication
(10) Pub. No.: US 2002/0057730 A1
(43) Pub. Date: May 16, 2002

(54) Spreading factor detector

(76) Inventors: Jonas Karlsson, Yokohama (JP); Jeonghoon Han, Yokosuka (JP)

Correspondence Address: Ronald L. Grudziecki, Esq., BURNS, DOANE, SWECKER & MATHIS, L.L.P., P.O. Box 1404, Alexandria, VA, 22313-1404, US

(21) Appl. No.: 09/921,917

(22) Filed: Aug. 6, 2001

Related U.S. Application Data
(60) Provisional application No. 60/223,032, filed on Aug. 4, 2000.

(51) Int. Cl. H04K 1/00; H04L 27/30

(52) U.S. Cl. 375/152

(57) ABSTRACT

A method for determining whether a zero rate or non-zero rate transmission has occurred, in a variable spreading factor CDMA system, which provides the solution to the problem of de-spreading received signals with incorrect spreading codes and reducing processing delays, is presented. The method utilizes information determined from the received signals, which include control and data channel information, to determine whether a zero rate or non-zero rate transmission has occurred, and generating the correct spreading factor based on that determination. The method is based in a spreading factor detector, which is subsequently able to be utilized in several types of multiple access interference cancellation receivers, which utilize interference cancellation techniques.

### PRIORITY INFORMATION

The present application claims priority under 35 U.S.C. §119(e) to U.S. Provisional application No. 60/223,032, filed on Aug. 4, 2000, the entire contents of which are herein expressly incorporated by reference.

### TECHNICAL FIELD OF THE INVENTION

The present invention involves the field of telecommunication systems, and the use of Code Division Multiple Access (CDMA) communications techniques in cellular radio communication systems. In particular, the present invention relates to the reduction of processing delay in multiple access interference cancellation algorithms.

### BACKGROUND

In modern mobile communication, there are several multiple access schemes such as FDMA (Frequency division multiple access), TDMA (Time division multiple access), and CDMA. For the third generation mobile communication system defined by 3^{rd} Generation Partnership Project (3GPP), CDMA has been adopted because of its high frequency efficiency, low probability of intercept, and so forth, compared to the other multiple access systems, e.g., TDMA and FDMA.

FIG. 1 illustrates a CDMA transmitter 100 based on Wideband CDMA system. The CDMA transmitter 100 combines a data channel (DPDCH: Dedicated Physical Data Channel) 102 and a control channel (DPCCH: Dedicated Physical Control Channel) 104, for transmission over an air interface. The DPDCH is used for transporting user data such as voice, data, etc. The data speed of the DPDCH varies (i.e. DPDCH is a variable data rate channel). The DPCCH is used for transporting control data.

FIG. 2 illustrates the structure of the DPDCH and the DPCCH of the W-CDMA uplink. As shown in FIG. 2, the DPDCH and the DPCCH each comprise a plurality of slots of 0.667 ms in duration. Fifteen slots form one frame of 10 ms duration (15×0.667 ms=10 ms). One slot of the DPCCH comprises Pilot bits which are utilized for channel estimation, TFCI (Transport Format Combination Indicator) bits, FBI (Feedback Information) bits and TPC (Transmit Power Control) bits, TFCI bits provide the receiver with information about the DPDCH, i.e. spreading factor, coding rate, repetition pattern, etc. The information provided by the TFCI bits are spread across all the slots within one frame.

As shown in FIG. 1, the data of the DPDCH 102 is input to multiplier 106A, where it is spread by spreading code (channelization code) Cx(y) 108. The code length of the spreading code Cx(y) 108 varies in response to the data rate of the DPDCH 102. Generally, the code length of the spreading code is defined by the spreading factor (SF). For example, if the SF=4, the spreading code is 4 chips in length. FIG. 5 illustrates spreading codes used in W-CDMA systems. In a W-CDMA system uplink, the spreading factor can vary from SF=4 up to SF=256 in response to the data rate of the DPDCH 102. Although the spreading factor may vary every frame, it does not vary within the same frame.

The control data of the (DPCCH) 104 is input to multiplier 106B. A second input of multiplier 106B is connected to spreading code Cu(v) 110 (in which the code length remains constant). The spread data channel and control channel output respectively from multipliers 106A and 106B are combined by adder 112. As illustrated in FIG. 1, the DPDCH is an In-phase signal and the DPDCH is a Quadrature-phase signal which are combined to form an I+jQ signal. The combined I+jQ signal is multiplied by scramble code SC1 120 by multiplier 106C. The scrambled combined data 122A from multiplier 106C is transformed into an RF signal by an RF circuit (not shown) and then is transmitted through an antenna (also not shown).

FIG. 3 illustrates a radio channel model of a CDMA system 300. CDMA signals 122A-K from a plurality of CDMA transmitters 100A-K are propagated on the radio channel 302. Noise 306 is added to the transmitted RF signal at the receiver, as illustrated by adder 304. The combined signal 308 is a combination of noise 306 (atmospheric, intentional and unintentional interference, and receiver noise) and the transmitted CDMA signals 122A-K.

It will be recognized that CDMA signals from other users (Tx2-TxK) influence the CDMA signal of the user Tx1 as interference signals which degrade the performance of the data detection by the receiver of the information transmitted by transmitter Tx1 122A. This is an example of unintentional interference. Therefore, it is preferable to reduce interference signals.

Various techniques for interference cancellation have been proposed in recent years. One of them is subtractive multi-stage interference cancellation. In subtractive multi-stage interference cancellation, by performing the de-spreading process and the symbol detection process to the received signal, data from each user is tentatively detected. The detected data is re-spread using spreading code of each user and the re-spread signals are subtracted from the received signal as replica signals of interference signals. The residual signal generated by the subtraction process is added to the re-spread signals of each user. Then, the de-spreading process, the symbol detection process and the re-spreading process are performed to the combined signals respectively. By repeating these processes, in a subtractive multi-stage interference cancellation, the influence of interference signals is reduced and performance of the data detection is improved.

Another technique for interference cancellation is an adaptive single user detector. In an adaptive single user detector, replica interference signals of other users are not generated. Instead, the spreading code, which is used for de-spreading process, is adjusted adaptively on the basis of the result of the symbol detection process so that the spreading code orthogonal to interference signals from other users can be obtained. By adjusting the spreading code, an adaptive single user detector is able to reduce the influence of interference signals and improve the performance of the data detection.

Any of these interference cancellation techniques generates a processing delay due to the complexity of the process. In case of the above-described W-CDMA systems, since the code length of the spreading code used varies which spreading factor has been used must be detected before starting the interference cancellation. In W-CDMA systems, if the whole frame is received, it the spreading factor which has been used can be identified on the basis of TFCI bits. However, waiting to completely receive the whole data frame generates further process delay. Since some services, e.g., voice services, require short processing delay, in order to make it feasible to use interference cancellation techniques in commercial systems, the processing delay (other than the interference cancellation process) should be reduced as much as possible.

FIG. 4 illustrates a conventional spreading factor detector 400. The spreading factor detector 400 comprises a de-scrambler 402, X-1 matched filters 6406 and a spreading factor detector 404. In the spreading factor detector 400, the received signal (output of antenna 601) is de-scrambled at de-scrambler 402 (with use of scrambling code 408) and then input into X-1 matched filters 406. Each X-1 matched filter 406 de-spreads the received signal according to the spreading code based on its unique spreading factor, Fx. Each de-spread signal, which are all somewhat different because each matched filter has a different spreading factor, is input to a spreading factor detector 404.

In the spreading factor detector 404, the mean-power is detected for each de-spread signal. The mean-power for each de-spread signal is shown as:

\overline{P}x(x=1, . . . , X-1)

The mean-power from each matched filter 406 is then compared to each other to determine the maximum mean-power. The spreading factor of the matched filter that corresponds to the maximum mean-power is selected, and the spreading factor detector 404 outputs the selected spreading factor as the spreading factor used for the received signal.

As described above, in a W-CDMA system, user data is assigned to the I-channel and the control data is assigned to the Q-channel (see FIG. 1). When user data is not transmitted, the data channel is inactive but the control channel is active. This situation is referred to as “zero rate” transmission. When both channels are active, the transmission state is referred to as “non-zero rate” transmission. Further, the spreading factor at the time when a zero rate transmission has occurred is defined as spreading factor 0, or a “zero rate” spreading factor.

In the above-described conventional spreading factor detector 400, the situation of zero rate transmission has not been considered at all. Therefore, if applying the spreading factor detector 400 to a W-CDMA uplink, the accurate detection of the spreading factor could not be performed in all circumstances. That is, the spreading factor detector 400 can not accurately detect a zero rate spreading factor.

When the possible spreading codes are orthogonal to each other the spreading factor detector 400 can detect non-zero rate spreading factors since there exists a difference between the mean-power from each matched filter. Spreading Codes placed in different code branches of the spreading code tree shown in FIG. 5, e.g., spreading code C_{4,2}, C_{8,6}, and C_{16,14}, are orthogonal. However, in the case that the possible spreading codes are not completely orthogonal each other (i.e. in the case that the possible spreading codes are in the same code branch shown in FIG. 5, e.g. spreading code C_{4,1}, C_{8,2} and C_{16,4}), the spreading factor detector 400 can not detect the non-zero rate spreading factor since there might not exist a difference between the mean-power from each matched filter. Therefore, a spreading factor detector which is able to detect non-zero rate spreading factor accurately in the case that the possible spreading codes are in the same code branch is needed.

### SUMMARY OF THE INVENTION

The invention involves a method for estimating a spreading factor in a receiver of a variable spreading factor CDMA system, comprising inputting a received signal into a plurality of matched filters, each matched filter having a unique spreading factor, de-spreading the received signal with a spreading code corresponding to the spreading factor and outputting a plurality of de-spread signals. Subsequently, a mean power is calculated for each of the plurality of output de-spread signals and finally a spreading factor of the received signal based on the calculated mean power is estimated.

The invention involves a second method for estimating a spreading factor in a receiver of a variable spreading factor CDMA system, comprising inputting a received signal into a plurality of matched filters, each matched filter having a unique spreading factor and de-spreading the received signal with a spreading code corresponding to the spreading factor, and outputting a plurality of de-spread signals and calculating an absolute amplitude for each of the plurality of de-spread signals. Following this, a matched filter integrand, MFAI_{X}, is calculated for each of the plurality of de-spread signals. Then, a matched filter difference, MFD_{X}, for each pair of adjacent matched filters is calculated and a spreading factor of the received signal based on the matched filter difference, MFD_{X}, is estimated.

The invention involves a method for determining whether a zero rate transmission has occurred in a wide band code division multiple access communications system, comprising calculating a first threshold value, a likelihood ratio, and then comparing the first threshold value to the likelihood ratio. Based on the comparison, a non-zero rate transmission has occurred if the likelihood ratio is greater than or equal to the first threshold value, or determining that a zero rate transmission has occurred if the likelihood ratio is less than the first threshold value.

The invention involves a second method for determining whether a zero rate transmission has occurred in a wide band code division multiple access communications system, comprising calculating a second threshold value, λ₂, a first test statistic, T₁(r) and then comparing the second threshold value to the first test statistic. Based on the comparison, a non-zero rate transmission has occurred if the first test statistic is greater than or equal to the second threshold value, or determining that a zero rate transmission has occurred if the first test statistic is less than the second threshold value.

The invention involves a third method for determining whether a zero rate transmission has occurred in a wide band code division multiple access communications system, comprising calculating a third threshold value, λ₃, a second test statistic, T₂(r), and then comparing the third threshold value to the second test statistic. Based on the comparison, a non-zero rate transmission has occurred if the second test statistic is greater than or equal to the third threshold value, or determining that a zero rate transmission has occurred if the second test statistic is less than the third threshold value.

The invention also involves a spreading factor detector, for use in a wideband code division multiple access communications system, comprising a de-scrambler, with an input connected to a received baseband signal, and a real signal output, and an imaginary signal output, a SIR processor, with an input connected to the imaginary signal output, and a plurality of SIR processor outputs, a plurality of matched filters, each matched filter having an input connected to the real signal output, and a matched filter output. Additionally, the spreading factor detector comprises a non-zero rate spreading factor detector having a plurality of inputs connected to the plurality of matched filter outputs, and a plurality of non-zero rate spreading factor detector outputs, and a zero rate spreading factor detector having a plurality of inputs connected to the plurality of non-zero rate spreading factor detector outputs and the plurality of SIR processor outputs, and an estimated spreading factor output signal.

### BRIEF DESCRIPTION OF THE DRAWINGS

The novel features believed characteristic of the invention are set forth in the appended claims. The invention itself, however, as well as other features and advantages thereof will be best understood by reference to the detailed description of the specific embodiments which follows, when read in conjunction with the accompanying drawings.

FIG. 1 illustrates a CDMA transmitter based on a Wideband CDMA (w-CDMA) system, which is defined by the 3^{rd} Generation Partnership Project (3GPP) as a 3^{rd} generation cellular system;

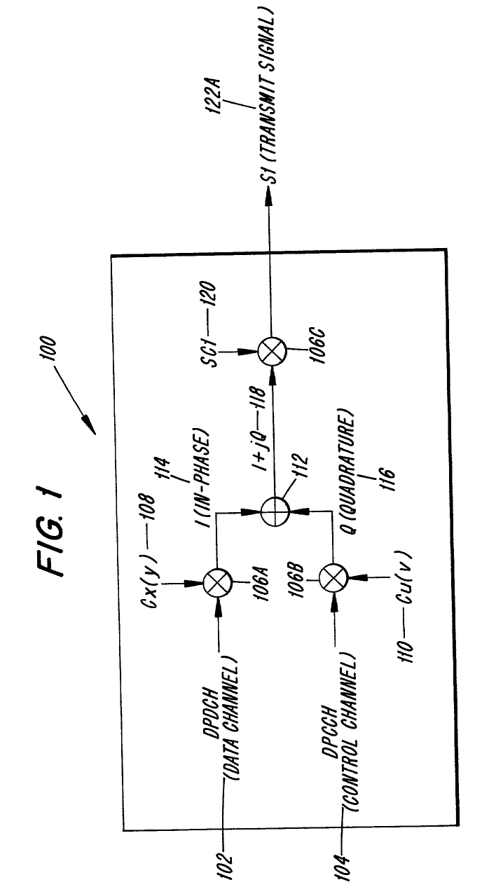

FIG. 2 illustrates the structure of the data channel and control channel in a w-CDMA uplink;

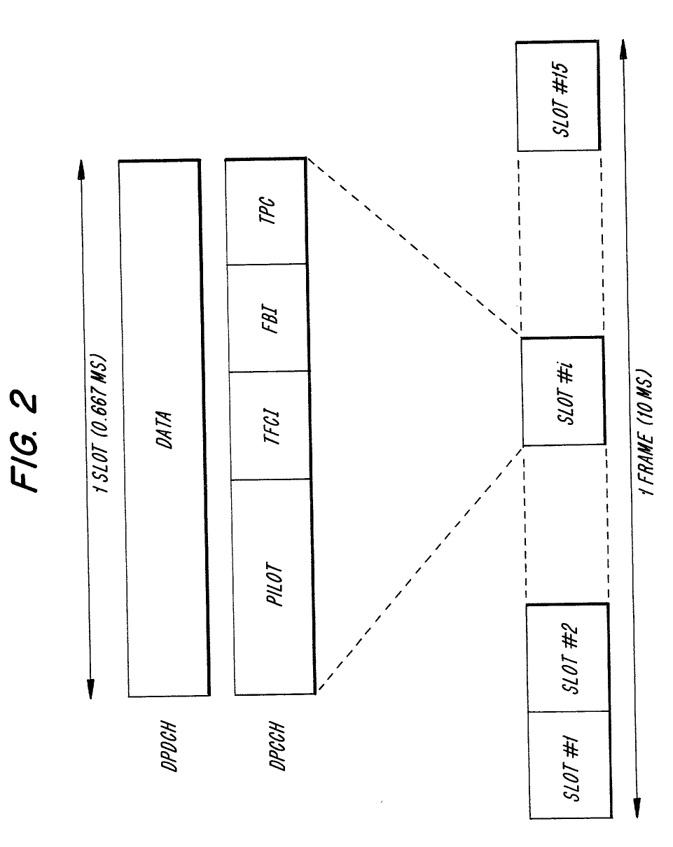

FIG. 3 illustrates a radio channel model of a CMDA system;

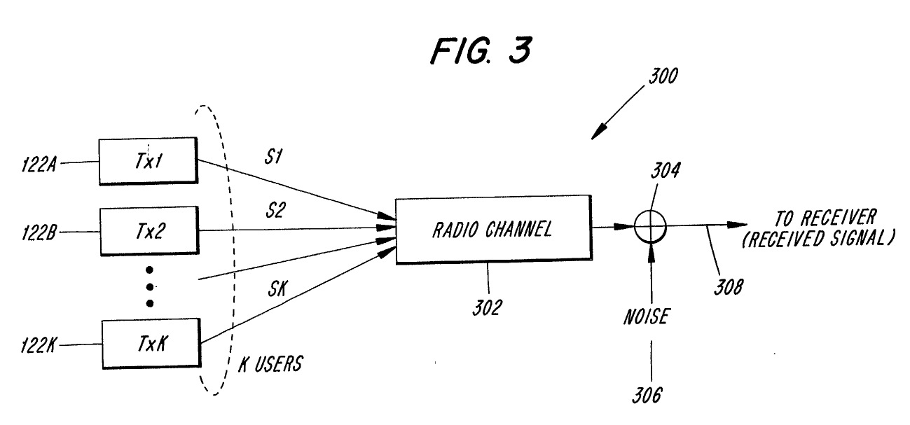

FIG. 4 illustrates a conventional spreading factor detector;

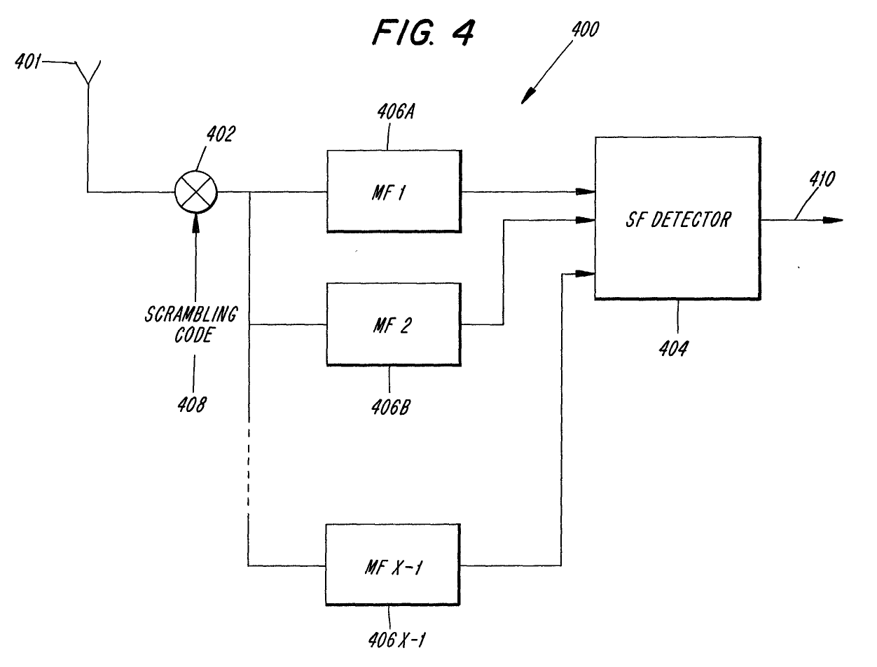

FIG. 5 illustrates a spreading code tree;

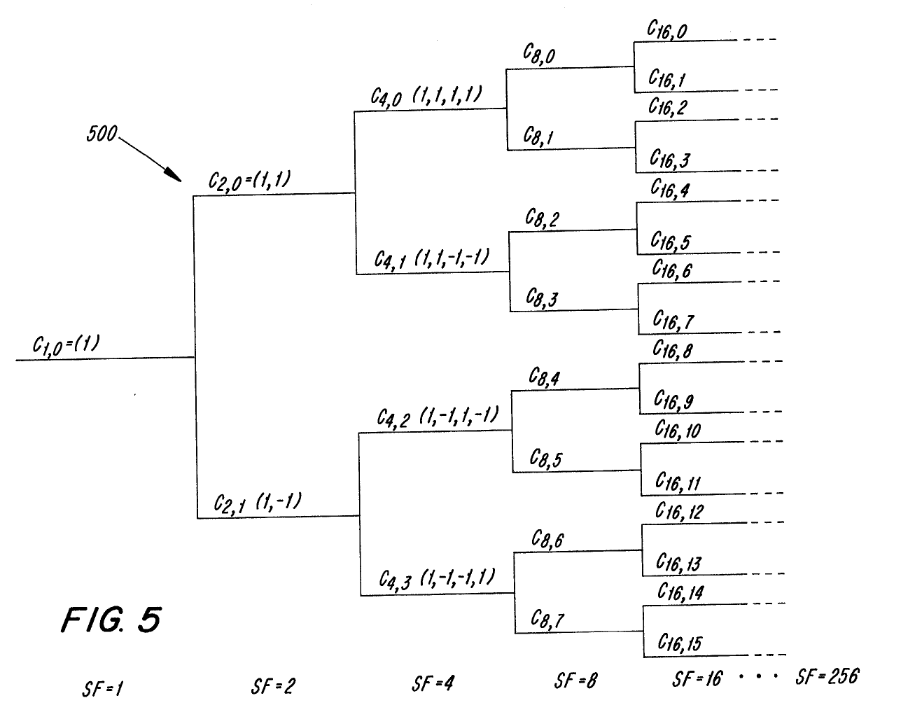

FIG. 6 illustrates a first spreading factor detector according to a preferred embodiment of the invention;

FIG. 7 illustrates a method for determining a non-zero rate spreading factor in the first spreading factor detector, according to an embodiment of the invention;

FIG. 8 illustrates a second spreading factor detector according to an embodiment of the invention;

FIG. 9 illustrates a method for determining a non-zero rate spreading factor in the second spreading factor detector, according to an embodiment of the invention;

FIG. 10 illustrates a method for determining whether a zero-rate or non-zero rate transmission has occurred according to an embodiment of the invention;

FIG. 11 illustrates a method for determining whether a zero rate or non-zero rate transmission has occurred according to an embodiment of the invention;

FIG. 12 illustrates a method for determining whether a zero or non-zero rate transmission has occurred according to an embodiment of the invention;

FIG. 13 illustrates a method for determining whether a zero rate or non-zero rate transmission has occurred according to an embodiment of the invention;

FIG. 14 illustrates a method for determining whether a zero rate or non-zero rate transmission has occurred according to an embodiment of the invention;

FIG. 15 illustrates a subtractive multi-stage interference cancellation receiver with a spreading factor detector of an embodiment of the invention;

FIG. 16 illustrates an interference cancellation unit with a spreading factor detector of an embodiment of the invention;

FIG. 17 illustrates input signals to an interference cancellation unit, in a subtractive multi-stage interference cancellation receiver;

FIG. 18 illustrates a modified multi-stage interference cancellation receiver with a spreading factor detector of an embodiment of the invention;

FIG. 19 illustrates an adaptive single user detector with a spreading factor detector of an embodiment of the invention;

FIG. 20 illustrates a large buffer interference cancellation receiver with a spreading factor detector of an embodiment of the invention;

FIG. 21 illustrates a parallel interference cancellation receiver with a spreading factor detector of an embodiment of the invention; and

FIG. 22 illustrates a buffer parallel interference cancellation receiver with a spreading factor detector of an embodiment of the invention.

### DETAILED DESCRIPTION OF THE INVENTION

The various features of the invention will now be described with reference to the figures, in which like parts are identified with the same reference characters.

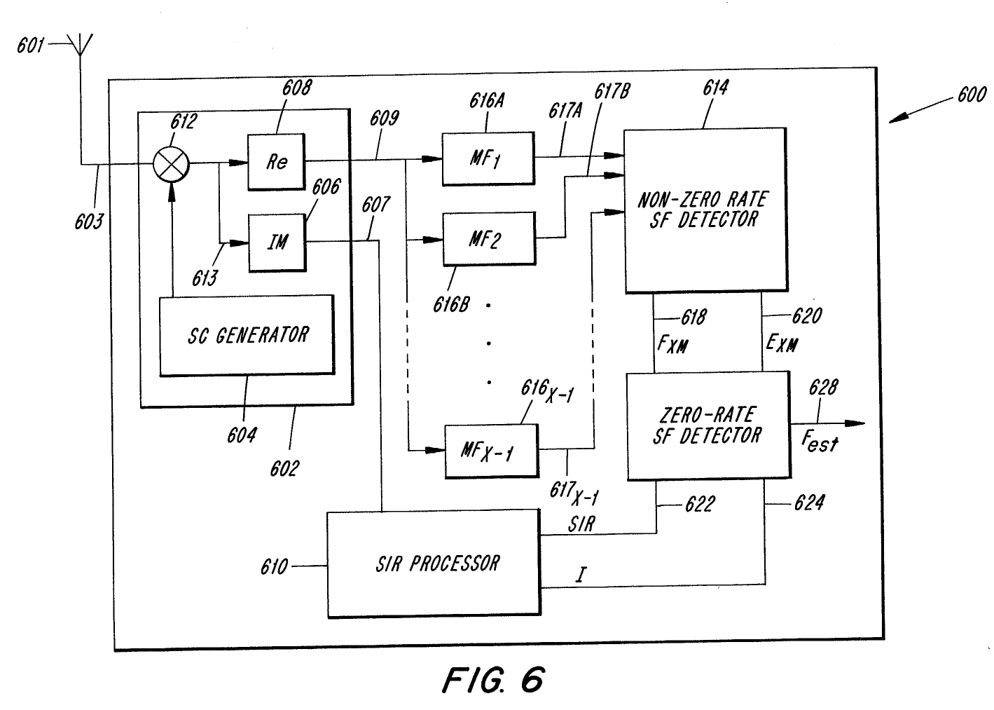

FIG. 6 illustrates a spreading factor detector according to a preferred embodiment of the invention. In FIG. 6, it is assumed that the spreading factors and associated spreading codes used by the CDMA transmitter are known to the CDMA receiver, i.e., there is a finite, known set of spreading factors and codes. Additionally, the possible spreading codes are orthogonal each other. In FIG. 6, baseband signal 603, received by antenna 601 is downconverted by an RF unit (not shown in FIG. 6). The baseband signal 603 is input to de-scrambler 602. De-scrambler 602 contains a multiplier 612, complex-conjugate scrambling code generator 604, real (Re) filter 608 and imaginary (Im) filter 606. Multiplier 612 multiplies the received signal 603 with the scrambling code generated by the complex conjugate scrambling code generator 604. The output of mixer 612 is a de-scrambled signal 613. The de-scrambled signal 613 is input to real (Re) filter 608 and imaginary (Im) filter 606. Since received signal 603 is a complex signal, Re filter 608 isolates the real component of the received signal 603, to provide a de-scrambled real signal 609, and Im filter 606 isolates the imaginary component of baseband signal 603, to provide de-scrambled imaginary signal 607. It is understood that filters 606 and 608 are not true filters, and instead, merely represent logical operations that occur within a microprocessor, upon execution of program command. Of course, these filters 606 and 608 may be structured by other filters comprised of discrete electronic components, as far as such operations are performed.

De-scrambled imaginary signal 607 is input to SIR processor 610. SIR processor 610 calculates the signal-to-interference ratio (SIR) based on the signal strength (S) and interference signal strength (I) (SIR=S/I). Methods of calculating the SIR are well known in the art, e.g., de-spreading the control channel, and calculating the signal strength and interference signal strength of the pilot bits which are placed within the control channel (i.e., DPCCH). SIR processor 610 outputs data channel SIR signal 622 and interference strength signal 624 to the zero rate spreading factor detector 626. Strictly speaking, data channel SIR signal 622 and interference strength signal 624 show the signal-to-interference ratio (SIR) and interference signal strength (I) of DPCCH. However, these values may be used as SIR and I of DPDCH. Of course, SIR and I of DPDCH may be calculated based on SIR and I of DPCCH according a predetermined method.

The de-scrambled real signal 609 is de-spread through the matched filters 616(A)-616(X-1). Each matched filter 616 has a unique spreading factor and de-spreads the de-scramble real signal 609 with a spreading code corresponding to the spreading factor. De-spread de-scrambled real signals 617(A)-(X-1) are input to the non-zero rate spreading factor detector 614. The Non-zero rate spreading factor detector 614 estimates a non-zero rate spreading factor that has the highest possibility of having been used for the data channel. It does this by calculating the mean power of each matched filter's output signal. It then compares all the mean powers and determines which is the maximum. The spreading factor of the matched filter which corresponds to the maximum mean power is the non-zero rate spreading factor for the data channel. The non-zero rate spreading factor detector 614 then calculates the signal energy of the output signal form the matched filter having the estimated spreading factor. Thus, there are two outputs from the non-zero rate spreading factor detector 614: an estimated non-zero rate spreading factor (F_{XM}) 618, and data channel signal energy (E_{XM}) 620. Both the estimated non-zero rate spreading factor 618, and data channel signal energy 620 are input to zero rate spreading factor detector 626.

The zero rate spreading factor detector 626 determines whether a zero rate or non-zero rate transmission has occurred and then outputs the final estimated spreading factor (Fₑₛₜ) 628. That is, the zero rate spreading factor detector 626 outputs the final estimated zero rate spreading factor 628 if a zero rate transmission has occurred, or the zero rate spreading factor detector 626 outputs the estimated non-zero rate spreading factor 618 if a non-zero rate transmission has occurred.

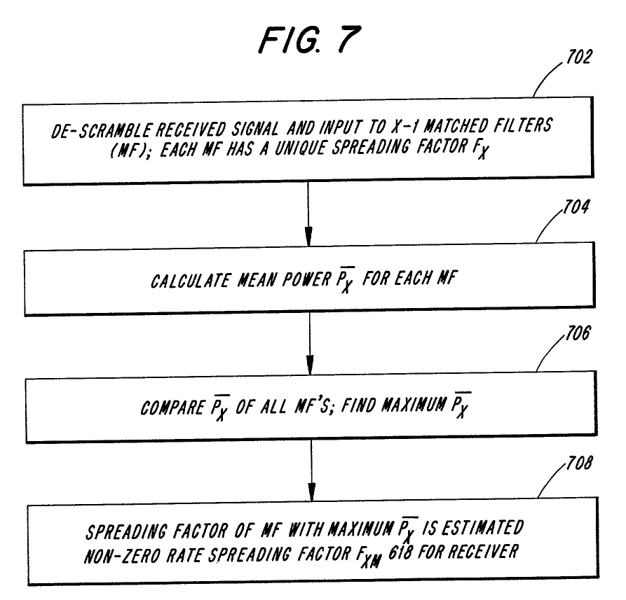

FIG. 7 illustrates a method for determining a non-zero rate spreading factor in the first spreading factor detector, according to an embodiment of the invention. In step 702 the signal is received, de-scrambled, and then the real part of the de-scrambled signal is input to X-1 matched filters. Each matched filter de-spreads the received signal according to the spreading code based on the unique spreading factor Fx assigned to it.

Steps 702-708 occur in the non zero rate spreading factor detector 614. In step 704, the mean-power P\overline{x} of each de-spread signal is calculated. In step 706, all the mean-power P\overline{x} are compared, to determine the maximum mean-power P\overline{x}m. In step 708, the spreading factor Fx of the matched filter that corresponds to the maximum mean-power is selected as the estimated non-zero rate spreading factor 618.

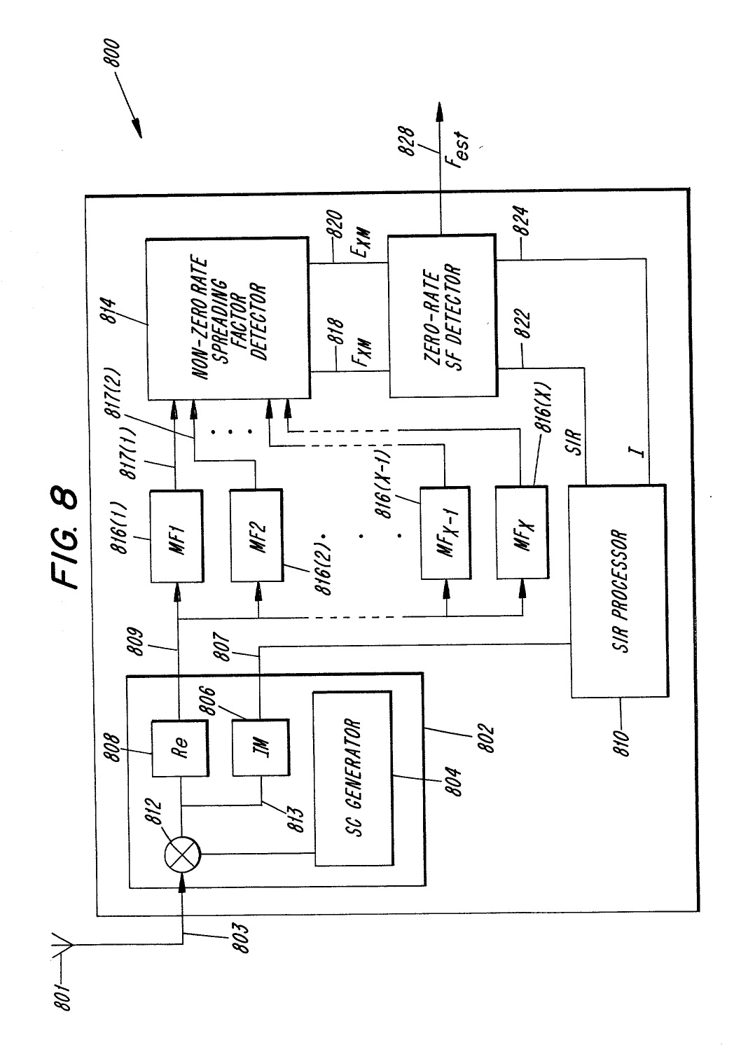

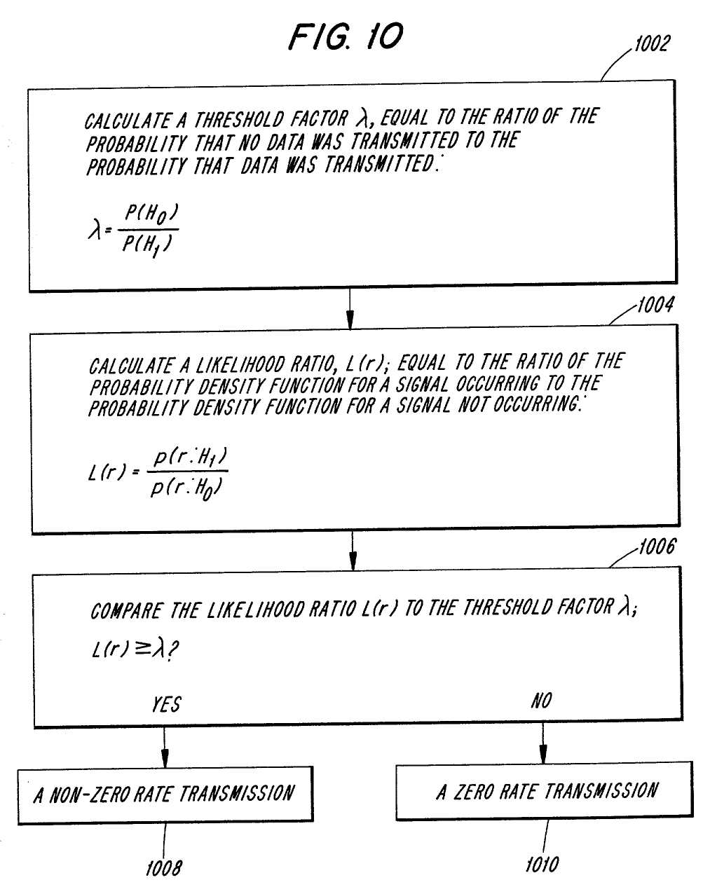

Operation of the zero rate spreading factor detector 626 is described in the method illustrated in FIGS. 10-14. The zero rate spreading factor detector 626 is used also in the second spreading factor detector 800 illustrated in FIG. 8 (zero rate spreading factor detector 826).

FIG. 8 illustrates a second spreading factor detector according to an embodiment of the invention. The difference between the first spreading factor detector 600 and the second spreading factor detector 800 is an additional matched filter in the second spreading factor detector 800, and the method for estimating the non-zero rate spreading factor.

In FIG. 8, it is assumed that the spreading factors and associated spreading codes used by the CDMA transmitter are known to the CDMA receiver, i.e., there is a finite known set of spreading factors and codes. Additionally, the possible spreading codes are in the same code branch. In FIG. 8, de-scrambled imaginary signal 807 (obtained by de-scrambler 802) is input to SIR processor 810, and then the data channel SIR signal 822 and interference strength signal 824 are calculated, and input to zero-rate spreading factor detector 826.

De-scrambled real signals 809 (obtained by de-scrambler 802) are input to X matched filters 816(I)-816(X), and then are de-spread through these matched filters. “X” refers to the number of the possible spreading codes (or spreading factors) +1, not including the non-zero rate spreading factor. Each matched filter 816 has a unique spreading factor and de-spreads the de-scrambled real signal with a spreading code corresponding to its particular spreading factor. Each matched filter 816 is allocated one of the spreading factors expected to be used at the transmitter, while X^{th} matched filter 816(X) is allocated a spreading factor two times as large as the X-1^{th} matched filter, which has the longest spreading factor of the possible spreading factors. For example, if the spreading factor of the X-1^{th} matched filter is 8 (e.g. code C_{8,2}), then the spreading factor of the X^{th} matched filter should be 16 (either code C_{16,4} or C_{16,5}). The nomenclature for designating spreading factors in a W-CDMA uplink is as follows: For a spreading factor F, spreading codes C_{F,F/4} are assigned (for matched filters 1 through X-1). The spreading code of the X^{th} matched filter, however, is shown as C_{2F,(2F/4+M)} where M=0 or 1.

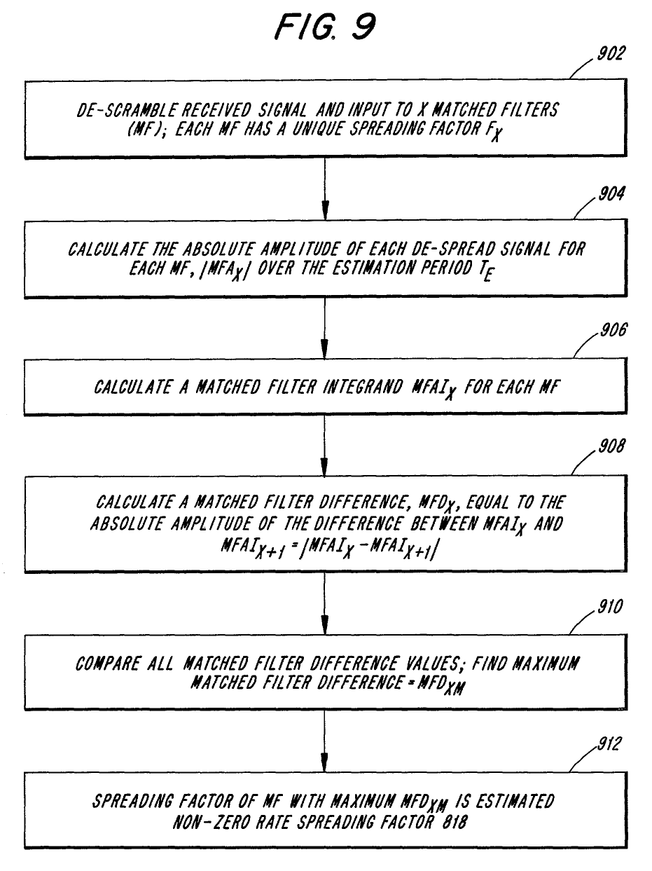

Signals 817(1)-(X) are de-spread, de-scrambled real signals, which are then input to the non-zero rate spreading factor detector 814. Non-zero rate spreading factor detector 814 estimates a non-zero rate spreading factor that has the highest possibility of having been used for the data channel. The non-zero rate spreading factor detector 814 calculates the absolute amplitude of each de-spread signal, for each matched filter 816, over a period of time equal to the estimation period, Tₑ (Tₑ equals the duration of the spreading code). Then, a matched filter integrand is calculated for each matched filter 816 output signal 817. After all the matched filter integrands have been determined, a matched filter difference is calculated, which equals the absolute amplitude of the difference between the matched filter integrands of adjacent matched filters. The maximum matched filter difference is then obtained and the spreading factor of the matched filter 816 corresponding to the maximum matched filter difference is the estimated non-zero rate spreading factor 818 for the receiver. These steps are discussed more fully with respect to FIG. 9. The non-zero rate spreading factor detector 814 has two outputs, an estimated non-zero rate spreading factor 818, and data channel signal energy 820, which are input to the zero rate spreading factor 826.

The zero rate spreading factor detector 826 determines whether a zero rate or non-zero rate transmission has occurred and then outputs the final estimated spreading factor 828. That is, the zero rate spreading factor detector 826 outputs the zero rate spreading factor if a zero rate transmission has occurred, or the zero rate spreading factor detector 826 outputs the estimated non-zero rate spreading factor 818 if a non-zero rate transmission has occurred.

FIG. 9 illustrates a method for determining a non-zero rate spreading factor in the second spreading factor detector, according to an embodiment of the invention. The method of FIG. 9 is used in conjunction with the second spreading factor detector 800 illustrated in FIG. 8. In step 902 the signal is received, de-scrambled, and input to X matched filters. Each matched filter de-spreads the received signal according to its assigned spreading code.

Steps 904-912 occur in the non-zero rate spreading factor detector 814. In step 904, the absolute amplitude of each de-spread signal is calculated. The absolute amplitude of each de-spread signal is calculated by summing, individually, the outputs from X matched filters over a period of time equal to the duration of the spreading code (estimation period, Tₑ) and taking the absolute value of the result. The amplitude signal of the X^{th} matched filter can be represented as MFA_{X}. The absolute amplitude signal from the X^{th} matched filter is therefore represented as |MFA_{X}|.

In step 906 a matched filter integrand is calculated for each |MFA_{X}|. The X^{th} matched filter integrand is shown as MFAI_{X}.

The matched filter integrand is defined as:

$${MFAI}_{X} = {\int }_{0}^{{T}_{e}} \vert {MFA}_{X} \vert ⅆ t$$

where Tₑ is the estimation period.

In step 908, the matched filter difference, MFD_{X} is calculated. The matched filter difference is defined as:

MFD_{X}=|MFAI_{X}−MFAI_{X+1}| (X=1, 2, . . . , X−1)

In step 910, all the matched filter difference values are compared. The maximum matched filter difference is found (represented as MFD_{XM}). In step 912, the spreading factor Fx of the matched filter that corresponds to the maximum matched filter difference MFD_{XM} is selected as the estimated non-zero rate spreading factor 818.

Mathematically, the operation of steps 902-910 can be shown as follows:

Z_{X}(t) is the output signal from the X-th matched filter. The absolute amplitude of Z_{X}(t) is |Z_{X}(t)| and is equivalent to |MFA_{X}| calculated in step 904. Then,

$${v}_{x} = {\int }_{0}^{{T}_{e}} \vert {Z}_{x} ( t ) \vert ⅆ t$$

where vₓ is the matched filter integrand MFAI_{X} (step 906). A row vector v={v₁, v₂, . . . , v_{X}} can be written, so that a difference vector w={w₁, w₂, . . . , w_{X}} can be determined, where w_{X} is defined as:

w_{X}=|vₓ−vₓ₊₁|, (X=1, 2, . . . , X−1)

This is equivalent to MFD_{X} according to step 908. Table 1 shows the calculations determining w_{X} when the number of matched filters X=8.

TABLE 1

| X | MFD_{X} | \|MFAI_{X} - MFAI_{X+1}\| |
|---|---|---|
| 1 | MFD₁ | \|MFAI₁ - MFAI₂\| |
| 2 | MFD₂ | \|MFAI₂ - MFAI₃\| |
| 3 | MFD₃ | \|MFAI₃ - MFAI₄\| |
| 4 | MFD₄ | \|MFAI₄ - MFAI₅\| |
| 5 | MFD₅ | \|MFAI₅ - MFAI₆\| |
| 6 | MFD₆ | \|MFAI₆ - MFAI₇\| |
| 7 | MFD₇ | \|MEAI₇ - MFAI₈\| |

The spreading factor of the matched filter associated with the maximum vector w is the estimated non-zero rate spreading factor 818. For example, if w₄ is the maximum w vector, then spreading factor of 4th matched filter is the estimated non-zero rate spreading factor 818.

The method of FIG. 7, previously described in relation to the first spreading factor detector 600 illustrated in FIG. 6, may also be used in the second spreading factor detector 800 illustrated in FIG. 8. However, in order for the method illustrated in FIG. 7 to be used in the second spreading factor detector 800, the output of the last matched filter 816(X) must be terminated; i.e., not connected to the non-zero rate spreading factor detector 814.

FIG. 10 illustrates a method for determining whether a zero-rate or non-zero rate transmission has occurred according to an embodiment of the invention. Several assumptions regarding the input signals are necessary in order to derive the method of FIG. 10. It is assumed the signal, s, is a zero mean, Gaussian, random process with a variance σₛ². Noise, nₒ, is AWGN (Additive White Gaussian Noise) with variance

$${σ}_{0}^{2} .$$

. That is, r˜N(0,σₒ²I) under H₀ and r˜N(0,(σₛ²+σₒ²)I) under H₁, where I is a unity matrix and 0 is an all zero matrix. The notation N(μ,σ²) denotes a Gaussian probability density function (pdf) with mean μ and variance σ².

The steps for determining whether a zero rate or non-zero rate transmission has occurred, take place in the zero rate spreading factor detectors 626 and 826 of FIGS. 6 and 8. The problem to be solved is to determine which transmission has occurred:

H₀ r[n]=n₀[n]: No data transmitted, i.e., zero rate transmission

H₁ r[n]=s[n]+n₀[n]: Data transmission, i.e., non-zero rate transmission.

In these equations, n=0, 1, 2, . . . N−1. N is the number of bits for Tₑ the estimation period. H₀ is the “noise only” scenario, (spreading factor equal to 0 is used) and H₁ is the “signal present” scenario (the non-zero rate spreading factor is used); and r[n] signifies the received signal, i.e., the n-th received bit.

In step 1002, a Threshold Factor λ is determined, using the following equation:

$$λ = \frac{P ( {H}_{0} )}{P ( {H}_{1} )}$$

where P(H₀) is the probability that no data was transmitted, or “noise only.” P(H₁) is the probability that data was transmitted, i.e. “signal present.” In general, these probabilities are not known. In lieu of knowing the probabilities, there are two alternate methods for calculating the Threshold Factor λ: the first is that the probabilities can either be set to fixed values (i.e., the probability of no data transmission equals a first fixed value, and the probability of data transmission equals a second fixed value), or alternatively, the probabilities can be adaptively set using information of the past received signal and a traffic model for the used service. In the latter case, the “fixed” values would be empirically determined over time.

In step 1004, a Likelihood Ratio, L(r) is determined:

$$L ( r ) = \frac{p ( r ; {H}_{1} )}{p ( r ; {H}_{0} )}$$

The numerator in the equation to determine L(r) is the value determined by the probability density function for a signal occurring, and the denominator is the value of the probability density function for a signal not occurring.

In step 1006, the Likelihood Ratio L(r) is compared to the Threshold Factor λ:

If L(r)≧λ (step 1008) then the transmission is a non-zero rate transmission (i.e. signal present) (“Yes” path out of decision step 1006).

If L(r)<λ (step 1010) then the transmission is a zero rate transmission (i.e. no signal present) (“No” path out of decision step 1006).

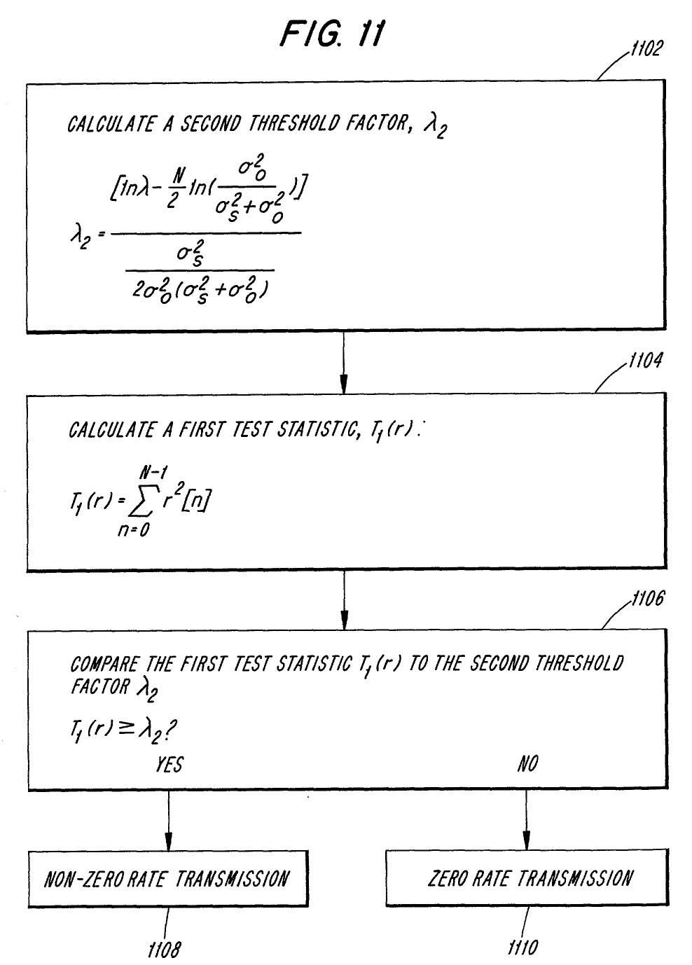

FIG. 11 illustrates a method for determining whether a zero rate or non-zero rate transmission has occurred according to an embodiment of the invention. The method illustrated in FIG. 11 is based on a statistical analysis of transmitted signals. Because it was assumed that the input signals are a Gaussian random process, the probability density functions in the Likelihood Ratio L(r) can be replaced by the probability density functions of a Gaussian random variable. Then, the Likelihood Ratio L(r) can be written as:

$$L ( r ) = \frac{\frac{1}{{[ 2 π ( {σ}_{s}^{2} + {σ}_{o}^{2} ) ]}^{N / 2}} exp [ - \frac{1}{2 ( {σ}_{s}^{2} + {σ}_{o}^{2} )} {\sum }_{n = 0}^{N - 1} {r}^{2} [ n ]}{\frac{1}{{[ 2 π {σ}_{o}^{2} ]}^{N / 2}} exp [ - \frac{1}{2 {σ}_{o}^{2}} {\sum }_{n = 0}^{N - 1} {r}^{2} [ n ]}$$

Then we take logarithm with respect to L(r), so that the log-Likelihood Ratio l(r) is:

$$l ( r ) = \frac{N}{2} ln ( \frac{{σ}_{o}^{2}}{{σ}_{s}^{2} + {σ}_{o}^{2}} ) + \frac{1}{2} [ \frac{{σ}_{s}^{2}}{{σ}_{o}^{2} ( {σ}_{s}^{2} + {σ}_{o}^{2} )} ] {\sum }_{n = 0}^{N - 1} {r}^{2} [ n ]$$

We can rewrite the equation in step 1006 for Likelihood Ratio L(r) and Threshold Factor λ, by taking the logarithm of both sides (recall that step 1006 was written as: L(r)≧λ):

l(r)≧ln(λ)

By rearranging the above equations (for l(r)), we have:

$${\sum }_{n = 0}^{N - 1} {r}^{2} [ n ] \geq {λ}_{2}$$

Here, we define a First Test Statistic T₁(r) as:

$${T}_{1} ( r ) = {\sum }_{n = 0}^{N - 1} {r}^{2} [ n ]$$

We define a Second Threshold Factor λ₂ as:

$${λ}_{2} = [ ln λ - \frac{N}{2} ln ( \frac{{σ}_{o}^{2}}{{σ}_{s}^{2} + {σ}_{o}^{2}} ) ] / [ \frac{{σ}_{s}^{2}}{2 {σ}_{o}^{2} ( {σ}_{s}^{2} + {σ}_{o}^{2} )} ]$$

In step 1102 the method calculates the Second Threshold Factor λ₂:

$${λ}_{2} = [ ln λ - \frac{N}{2} ln ( \frac{{σ}_{o}^{2}}{{σ}_{s}^{2} + {σ}_{o}^{2}} ) ] / [ \frac{{σ}_{s}^{2}}{2 {σ}_{o}^{2} ( {σ}_{s}^{2} + {σ}_{o}^{2} )} ]$$

As before, the value of the Threshold Factor λ is based on empirical measurements.

In step 1104, the First Test Statistic T₁(r) is calculated:

$${T}_{1} ( r ) = {\sum }_{n = 0}^{N - 1} {r}^{2} [ n ]$$

where r is the received signal.

In step 1106, the First Test Statistic T₁(r) is compared to the Second Threshold Factor λ₂:

If T₁(r)≧λ2 (step 1108) then the transmission is a non-zero rate transmission, i.e., signal present (“Yes” path out of decision step 1106).

If T₁(r)<λ₂ (step 1110) then the transmission is a zero rate transmission, i.e., no signal present (“No” path out of decision step 1106).

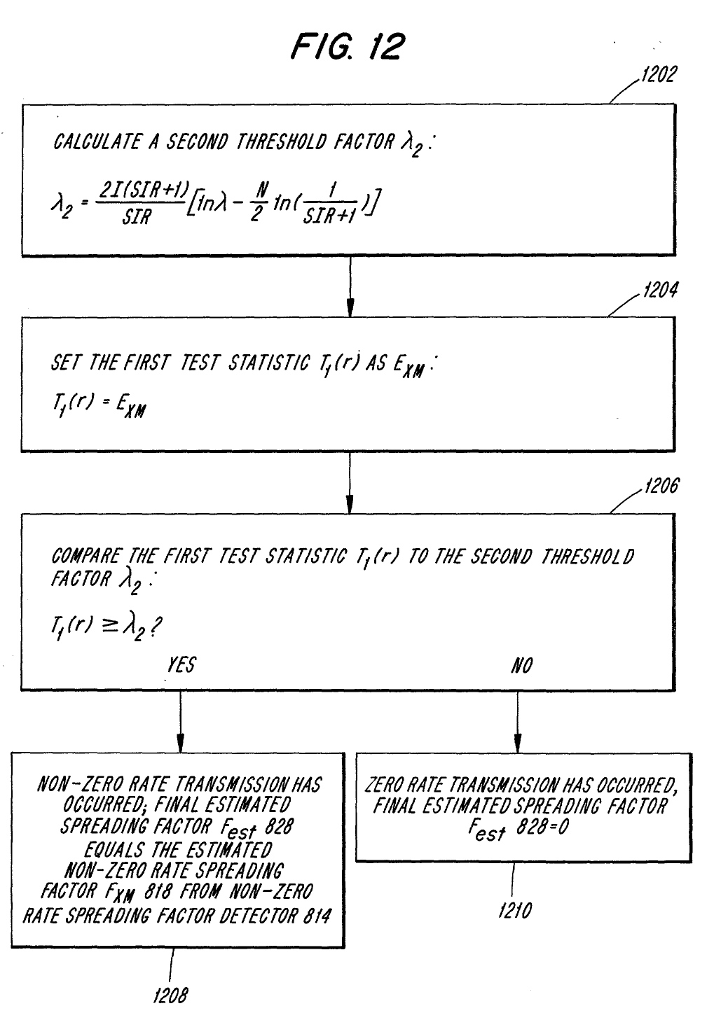

FIG. 12 illustrates a method for determining whether a zero or non-zero rate transmission has occurred according to an embodiment of the invention. The method illustrated in FIG. 12, for determining whether a non-zero rate or zero rate transmission has occurred, is used in conjunction with the spreading factor detectors 600 and 800 of FIGS. 6 and 8. The method illustrated in FIG. 12 is itself based on the method illustrated in FIG. 11. The method illustrated in FIG. 12 presupposes that a determination of the estimated non-zero rate spreading factor 818 (or 618) has already been determined. In essence, FIG. 12 begins where the methods of FIGS. 7 and 9 ends, i.e., now, with these additional steps, it is possible to determine whether a zero rate or non-zero rate transmission has occurred. The steps of the method illustrated in FIG. 12 occur in the zero rate spreading factor detector 626 (or 826).

There are three signals used in the method of FIG. 12: These are the estimated non-zero spreading factor 618 (or 818), data channel signal energy 620 (or 820) (E_{XM}), and the data channel SIR signal 622 (or 822). The method of FIG. 12 does not need the interference strength signal 624 (or 824) from SIR processor 610 (or 810). Each input can be represented as follows:

$$SIR ( 822 ) = \frac{S}{I} ;$$

the calculated signal-to-interference

ratio for DPDCH 102, calculated by SIR processor;

$${E}_{XM} = {{\int }_{0}}^{Te} {p}_{XM}$$

is the calculated data channel signal energy from the matched filter having the estimated spreading factor; and

F_{XM} is the estimated non-zero rate spreading factor from the non-zero rate spreading factor detector.

In step 1202, data channel SIR signal 622 (or 822), interference strength signal 624 (or 824), and the First Threshold Factor λ are used to calculate the Second Threshold Factor λ₂:

$${λ}_{2} = \frac{2 I ( SIR + 1 )}{SIR} [ ln λ - \frac{N}{2} ln ( \frac{1}{SIR + 1} ) ]$$

In step 1204, the data channel signal energy E_{XM} 620 (or 820) is set to the First Test Statistic T₁(r), which is derived from FIG. 11:

T₁(r)=E_{XM}

In step 1206, the Second Threshold Factor λ₂ is compared to the First Test Statistic T₁(r), (i.e., the data channel signal energy E_{XM} 620 (or 820)) from the matched filter 616 (or 816) having the estimated non-zero rate spreading factor 618 (or 818):

If T₁(r)≧λ₂ (step 1208), then a non-zero rate transmission has occurred (“Yes” path out of decision step 1206). The estimated non-zero spreading factor F_{XM} from the non-zero rate detector is the final estimated spreading factor Fₑₛₜ.

If T₁(r)≧λ₂ (step 1210), then a zero rate transmission has occurred (“No” path out of decision step 1206). In this instance the final estimated spreading factor Fₑₛₜ is zero.

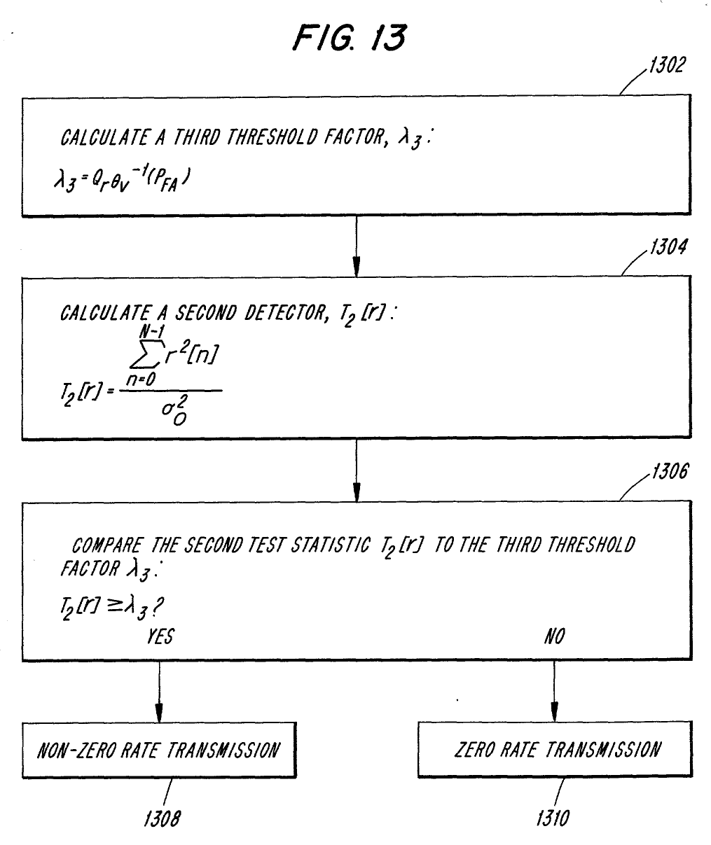

FIG. 13 illustrates a method for determining whether a zero rate or non-zero rate transmission has occurred according to an embodiment of the invention. The second statistical analysis method for determining whether a zero rate or non-zero rate transmission has occurred is based on the chi-squared probability density function (pdf) of r with v degree of freedom, where:

$$r = {\sum }_{i = 0}^{v} {r}_{i}^{2}$$

The right-tail probability of Rᵥ² random variable is defined for even v as:

$${Q}_{{R}_{v}^{2}} = exp ( - \frac{1}{2} r ) {\sum }_{k - 0}^{v / 2 - 1} \frac{{( r / 2 )}^{2}}{k !}$$

The probability of deciding H₁ (non-zero rate transmission), when H₀ (zero-rate transmission) is true, is referred to as probability of false alarm P_{FA}:

P_{FA}=P{T₁(r)>λ₂;H₀}

$$\begin{matrix}{P}_{FA} = P \{ {T}_{1} ( r ) > {λ}_{2} ; {H}_{0} \} \\ = P \{ {T}_{1} ( r ) / {σ}_{0}^{2} > {λ}_{2} / {σ}_{0}^{2} ; {H}_{0} \} \\ = {Q}_{{R}_{v}^{2}} ( r / {σ}_{0}^{2} )\end{matrix}$$

=Q_{R}_{ᵥ}_{²}(r/σ₀²)

The probability o f a false alarm is the value of the chi-squared probability density function given that T₁(r) is larger than λ₂, when a zero-rate transmission has occurred. In other words, its the probability a mistake is made in ascertaining when a non-zero rate transmission has occurred, when in actuality a zero-rate transmission has occurred. Ideally, false alarm probabilities should be as small as possible, and even more ideally, negligible.

A Second Test Statistic T₂(r), is defined as follows:

$${T}_{2} ( r ) = \frac{{T}_{1} ( r )}{{σ}_{0}^{2}} > {Q}_{{R}_{v}^{2}}^{- 1} ( {P}_{FA} )$$

A Third Threshold Factor λ₃ is defined as:

$${λ}_{3} = {Q}_{{R}_{v}^{2}}^{- 1} ( {P}_{FA} ) ;$$

where Q_{R}_{²}⁻¹ is the inverse of the right-tail probability for a Rᵥ² random variable.

In step 1302 the method calculates the Third Threshold Factor λ₃:

$${λ}_{3} = {Q}_{{R}_{v}^{{2}^{- 1}}} ( {P}_{FA} )$$

where the value of P_{FA} is decided on empirical measurements or is adaptively set on the basis of the past received signal and other conditions.

In step 1304, the Second Test Statistic, T₂(r) is calculated:

$${T}_{2} ( r ) = {\sum }_{n = 0}^{N - 1} {r}^{2} [ n ] / {σ}_{0}^{2}$$

In step 1306, the Second Test Statistic T₂(r) is compared to the Third Threshold Factor λ₃:

If T₂(r)≧λ₃ (step 1308) then the transmission is a non-zero rate transmission, i.e., signal present (“Yes” path out of decision step 1306).

If T₂(r)<λ₃ (step 1310) then the transmission is a zero rate transmission, i.e., no signal present (“No” path out of decision step 1306).

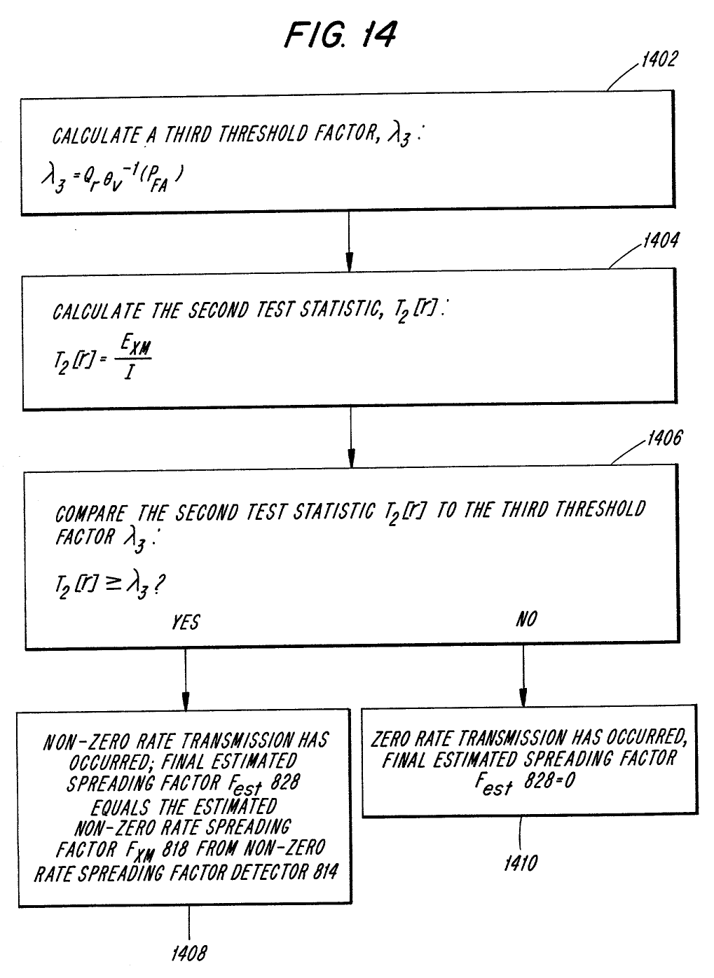

FIG. 14 illustrates a method for determining whether a zero rate or non-zero rate transmission has occurred according to an embodiment of the invention. The method illustrated in FIG. 14, is used in conjunction with the spreading factor detectors 600 and 800 of FIGS. 6 and 8. The method illustrated in FIG. 14 is itself based on the method illustrated in FIG. 13. The method illustrated in FIG. 14 presupposes that a determination of the estimated non-zero rate spreading factor 618 (or 818) has already been determined. In essence, FIG. 14 (as was the case regarding FIG. 12), begins where the method of FIG. 7 or 9 ends, i.e., now, with these additional steps, it is possible to determine whether a zero rate or non-zero rate transmission has occurred. The steps of the method illustrated in FIG. 14 occur in the zero rate spreading factor detector 626 (or 826).

There are three signals used in the method of FIG. 14. These are the estimated non-zero rate spreading factor 618 (or 818), the data channel signal energy 620 (or 820), and interference strength signal 624 (or 824). The method does not utilize the data channel SIR signal 622 (or 822) from SIR processor 610 (or 810).

The data channel signal energy (E_{XM}) 620 (or 820), is determined by integrating the mean power of the signal generated by the matched filter 616 (or 816) that produced the estimated non-zero rate spreading factor (F_{XM}) 620 (or 820), over a period of time equal to the estimation period, Tₑ:

$${E}_{XM} = {{\int }_{0}}^{Te} {p}_{XM}$$

In step 1402, interference strength signal (I) 624 (or 824) and the Threshold Factor λ are used to calculate the Third Threshold Factor λ₃:

$${λ}_{3} = {Q}_{{R}_{v}^{2}}^{- 1} ( {P}_{FA} )$$

In step 1404, the Second Test Statistic, T₂(r) is calculated:

$${T}_{2} ( r ) = \frac{{E}_{XM}}{I}$$

The Second Test Statistic T₂(r) is defined as the ratio of the signal energy of the matched filter producing the estimated non-zero rate spreading factor F_{XM} 620 (or 820), to the interference strength signal I 624 (or 824).

In step 1406, the Third Threshold Factor λ₃ is compared to the second test statistic T₂(r).

If T₂(r)≧λ₃ (step 1408) then a non-zero rate transmission has occurred (“Yes” path out of decision step 1406). The estimated non-zero rate spreading factor F_{XM} from the non-zero rate spreading factor detector is the final estimated spreading factor Fₑₛₜ.

If T₂(r)<λ₃ (step 1410) then a zero rate transmission has occurred (“No” path out of decision step 1408). In this instance the final estimated spreading factor Fₑₛₜ is zero.

The spreading factor detectors 600 and 800 have been shown to have many inventive features. These include the method for determining a non-zero rate spreading factor and several methods for determining whether a zero-rate transmission has occurred. However, using the spreading factor detector 600 or 800 in various types of CDMA spread spectrum receivers provides features not previously known or anticipated. Several types of receivers can incorporate the spreading factor detector 600 or 800. The first type is an interference cancellation (IC) receiver, of which there are several sub-types. In each of the receivers discussed below, although the spreading factor detectors are considered to be interchangeable, there is a requirement regarding each type: When the spreading codes are orthogonal to each other, spreading factor detector 600 is to be used; when the spreading codes are in the same branch according to 3GPP, spreading factor detector 800 is to be used.

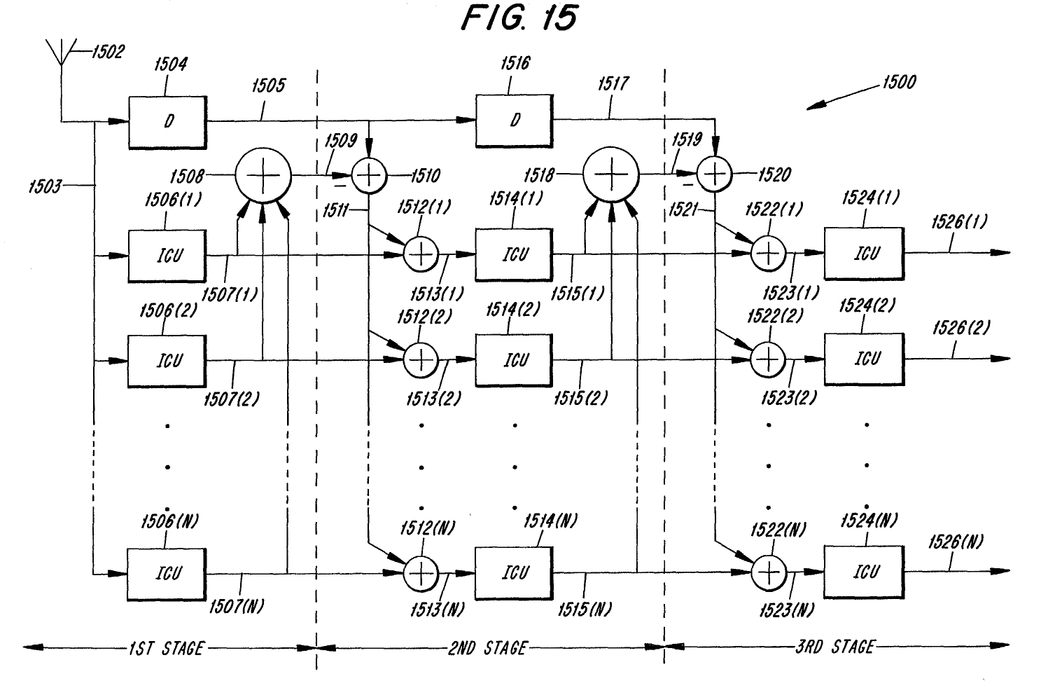

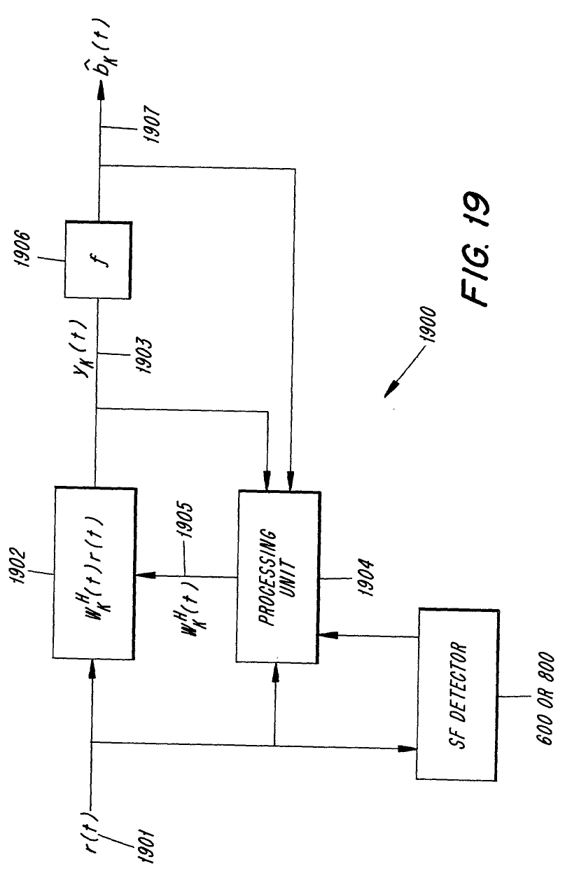

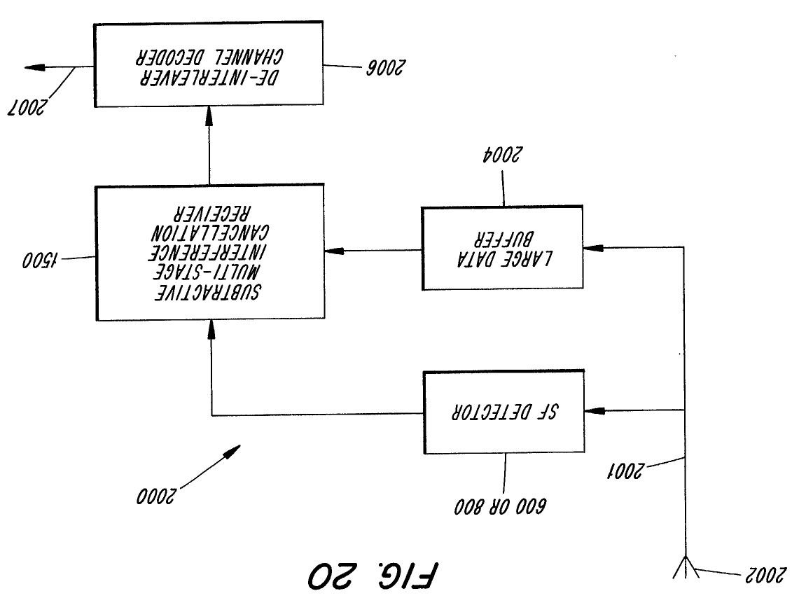

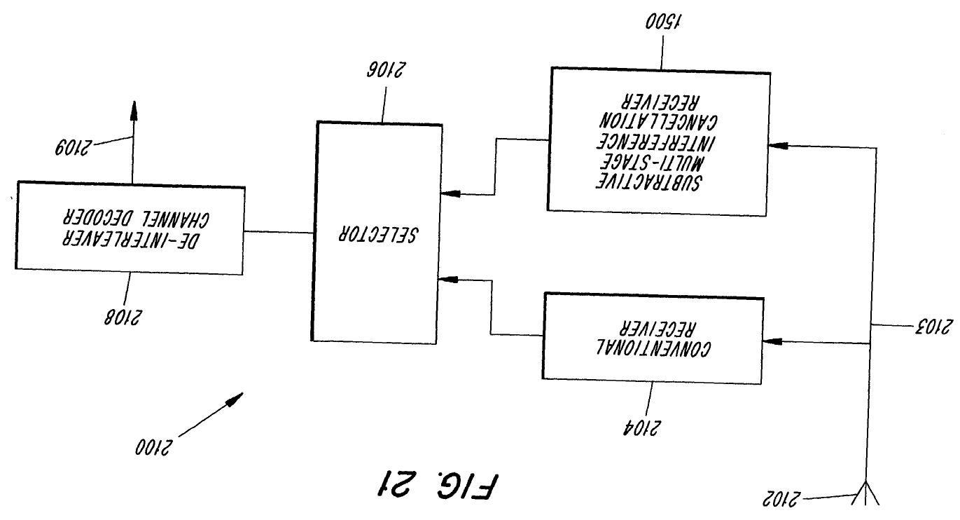

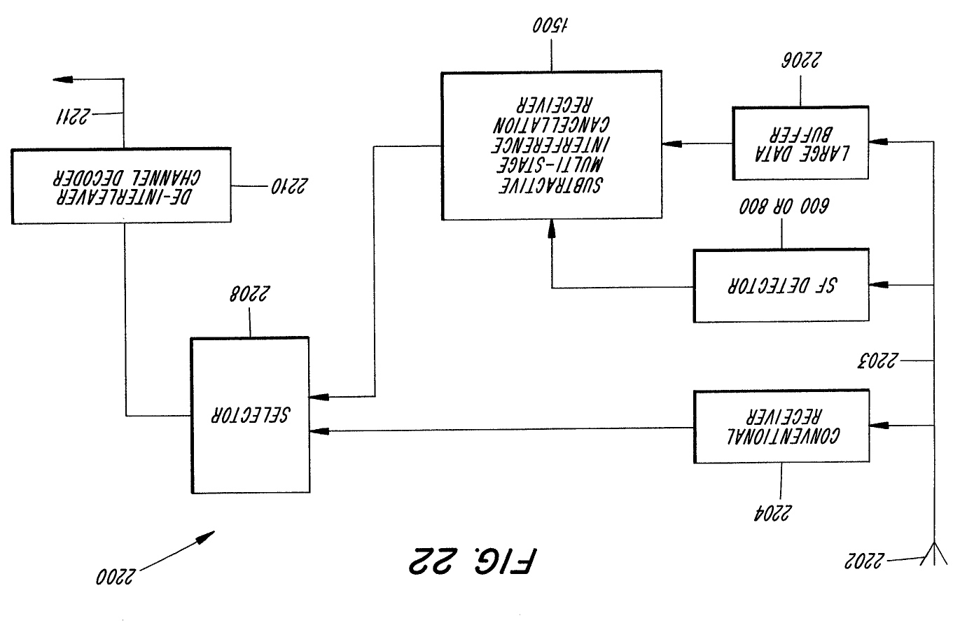

The first sub-type is a subtractive multi-stage IC receiver, discussed with regards to FIGS. 15-18; a second sub-type is an adaptive single user detector, discussed with regards to FIG. 19; a third sub-type is a large buffer IC receiver, discussed with regards to FIG. 20; and the last, and fourth sub-type is a parallel interference cancellation receiver, discussed with regard to FIGS. 21-22. Each will be discussed in turn.

FIG. 15 illustrates a subtractive multi-stage interference cancellation receiver with a spreading factor detector of an embodiment of the invention. The subtractive multi-stage interference cancellation receiver 1500 has three stages. The first stage has the following components: an antenna 1502, a first stage delay 1504, a plurality of first stage interference cancellation units (ICU) 1506 (each ICU, regardless of the first, second or third stage, contains the spreading factor detector 600 or 800), and a first stage first adder 1508. The second stage of the multi-stage interference cancellation receiver 1500 contains similar components as the first stage: a second stage delay 1516, a second stage first adder 1510, a plurality of second stage second adders 1512, a plurality of second stage ICUs 1514 and a second stage third adder 1518. The third stage of the multi-stage interference cancellation receiver comprises a third stage first adder 1520, a plurality of third stage second adders 1522, and a plurality of third stage ICUs 1524. The outputs of the third stage ICUs 1524 are identified as output signals 1526.

The subtractive multi-stage interference cancellation receiver 1500 works in the following manner. The baseband signal 1503 is input to the first stage delay 1504, and each first stage ICU 1506. Each first stage ICU 1506 contains spreading factor detector 600 or 800, and performs a de-spreading process on the basis of the spreading factor detected by the spreading factor detector 600 or 800. That is, each first stage ICU 1506 de-spreads the baseband signal 1503 with a spreading code corresponding to the estimated non-zero rate spreading factor 618 or 818, tentatively detects received symbols from the de-spread signal, and then re-spreads the detected symbols again with a spreading code. The re-spread signals output from each first stage ICU 1506 are combined by a first stage first adder 1508 as replica signals of interference signals, and then the combined signal is subtracted from the received signal output from the first stage delay 1504, by a second stage first adder 1510. The residual signal generated by the second stage first adder 1510 is input to each second stage second adder 1512, then added to the output signals from each first stage ICU 1506. Output signals from each second stage second adder 1512 are input to each second stage ICU 1514, respectively. Each second stage ICU 1514, in the same manner as the first stage ICU, generates a re-spread signal on the basis of an estimated spreading factor. Then, the re-spread signals are combined and subtracted from the received signal as interference replica signals through second stage third adder 1518, and third stage first adder 1520. In the third stage (and following stages, if applicable), the interference cancellation process is performed in the same manner as the second stage. Thus, the subtractive multi-stage interference cancellation receiver 1500 generates received signals 1526, in which components of interference signals are reduced, by performing the de-spreading and re-spreading process with the spreading code corresponding to the estimated non-zero rate spreading factor 618 or 818 and subtracting the re-spread signals from the received signal as interference replica signals.

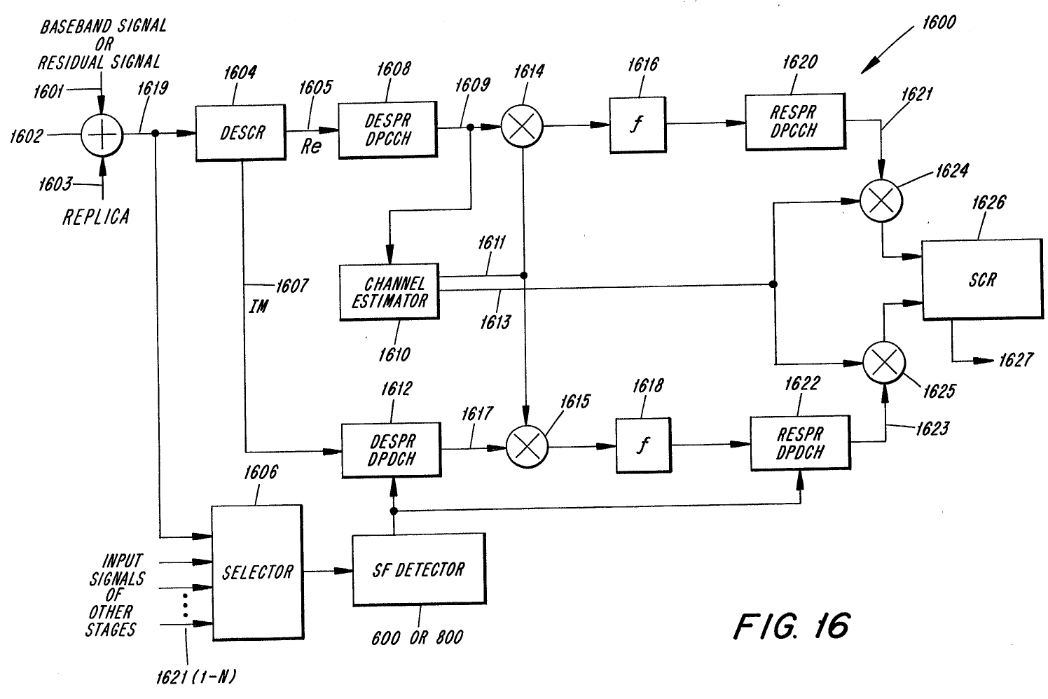

FIG. 16 illustrates an interference cancellation unit with a spreading factor detector of an embodiment of the invention. FIG. 16 illustrates ICUs 1506, 1514 and 1522, as shown in FIG. 15. In ICU 1600, an input signal 1619 from a first adder 1602 is input to a de-scrambler 1604 and a selector 1606. In case of the first stage, the input signal 1619 is the baseband signal 1601, and in case of the second and following stage, the input signal 1619 is the signal generated by adding the residual signal to the output signal (replica signal) 1603 from the prior stage.

The selector 1606 has other input signals 1607(1)-1607(N). These signals are the output signals of ICUs of other stages. Further, the selector 1606 has a buffer to store input signals, and selects one or a plurality of input signals from the stored signals and then outputs them to the spreading factor detector 800 (or 600). The spreading factor detector 800 (or 600) determines a final estimated spreading factor 628 (or 828) used in the data channel (DPDCH) and then outputs it to a de-spreader 1612 and a re-spreader 1622.

De-scrambler 1604 has a de-scramble code generator, and de-scrambles input signal 1619 according to the de-scramble code output from the de-scramble code generator. In de-scrambler 1604, a real component (Re) 1605 and an imaginary component (Im) 1607 of the de-scrambled signal are extracted. The real component 1605 is output to de-spreader 1608 and the imaginary component 1607 is output to de-spreader 1612.

The first de-spreader 1608 is a de-spreader for the control channel (DPCCH), and de-spreads the input signal 1619 according to a spreading code of the control channel, and then outputs the de-spread input signal 1609 to a multiplier 1614 and a channel estimator 1610.

The channel estimator 1610 estimates a channel variation on the basis of the pilot bits of the control channel. The channel estimator 1610 has two outputs: the first is a complex conjugate estimated channel factor 1611, and the second is a channel factor 1613. The complex conjugate estimated channel factor 1611 is input to a first multiplier 1614 and a second multiplier 1615. The channel factor 1613 is input to a third multiplier 1624 and a fourth multiplier 1625.

The first multiplier 1614, by multiplying the de-spread real signal 1609 with a conjugate value of the channel factor (complex conjugate estimated channel factor 1611), reduces the influence of the channel variation. A first detector 1616 tentatively detects symbols of the control channel from the output signal from the first multiplier 1614. A first re-spreader 1620, by re-spreading the detected symbols according to the spreading code for the control channel, generates the re-spread signal.

A second de-spreader 1612 for the data channel (DPDCH) also has a spreading code generator, and generates a spreading code corresponding to the final estimated spreading factor 628 (or 828) determined by the spreading factor detector 800 (or 600). Then, the second de-spreader 1612 de-spreads the Im signal 16-7 according to the spreading code and outputs the de-spread Im signal 1617 to a second multiplier 1615.

The second multiplier 1615, in the same manner as the first multiplier 1614, multiplies the de-spread IM signal 1617 with a conjugate value of the channel factor (complex conjugate estimated channel factor 1611) which reduces the influence of the channel variation. A second detector 1618 tentatively detects symbols of the control channel from the output signal from the second multiplier 1615.

A second re-spreader 1622 also has a spreading code generator, and generates a spreading code corresponding to the final estimated spreading factor 628 (or 828) determined by the spreading factor detector 800 or (600). Then, the second re-spreader 1622 re-spreads the detected symbols and outputs the re-spread signal to fourth multiplier 1625.

The third and fourth multipliers 1624 and 1625 multiplies the input signal with re-spread Re signal 1621 and re-spread Im signal 1623, respectively, the channel factor 1613 respectively, which generates a signal which incorporates the influence of channel variation. Scrambler 1626 combines the signals output from multipliers 1624 and 1625, and then generates scrambled ICU output signal 1627 by multiplying the combined third and fourth multiplier output signals by a scrambling code. Thus, ICU 1600, by performing a de-spreading and re-spreading process, generates a replica signal of each user, which is regarded by other users as an interference signal.

As described above, the subtractive multi-stage interference cancellation receiver 1500 needs to know the final estimated spreading factor 628 (or 828) before starting the interference cancellation process. By using the spreading factor detector 800 (or 600), the receiver 1500 can utilize the spreading factor. However, because there are multiple stages in the subtractive multi-stage interference cancellation receiver 1500, implementation of the spreading factor detector 800 (or 600) can be more sophisticated.

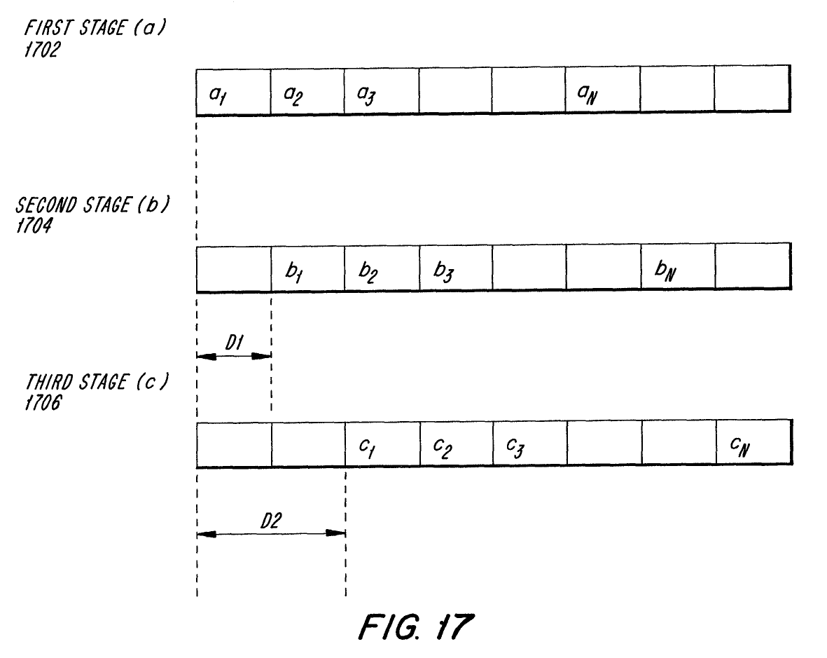

FIG. 17 illustrates input signals to an interference cancellation unit, in a subtractive multi-stage interference cancellation receiver. The signal 1702 shows the input signal to the first stage, the signal 1704 shows the input signal to the second stage, and signal 1706 shows the input signal to the third stage. Notation a, b and c means the first stage input signal, the second stage input signal and the third stage input signal, respectively. Further, the subscript number of notation 1, 2 and 3 means a slot number.

In the subtractive multi-stage interference cancellation receiver 1500, the input signals will be delayed compared with each other, because of the processing delay in each stage. For example, in FIG. 17, the time difference between the first stage and the second stage is D1 (which is equal to approximately one slot), and the time difference between the first stage and the third stage is D2 (which is equal to approximately two slots). This means, for example, the signal of the slot 1 (which is shown in FIG. 17 by notation a₁, b₁, and c₁) arrives at the second stage with the time delay D1, and arrives at the third stage with the time delay D2.

The difference between the input signals 1702, 1704, 1706 is that the input signal 1702 is the signal upon which that the interference cancellation process has not yet been performed, the input signal 1704 is the signal that the interference cancellation process has been performed one time, and the input signal 1706 is the signal that the interference cancellation process has been performed two times. For example, signal 1702 could be the input to ICU 1506(1) of FIG. 15. Signal 1704 could be the input to ICU 1514(1), and signal 1706 the input to ICU 1522(1).

The accuracy of the final estimated spreading factor 628 (or 828) will vary depending on which information is utilized. For example, when estimating the spreading factor for a certain slot, if using not only the information from the slot but also the information from the previous slots, a more accurate final estimated spreading factor 628 (or 828) will be obtained, because the amount of the data available to estimate the spreading factor increases. Further, greater accuracy will be obtained if still more information from other stages (post interference cancellation) is used because of the interference cancellation process.

Thus, various systems and methods for estimating the spreading factor in a subtractive multi-stage interference cancellation receiver are available depending on which information is used. The systems and methods for providing for enhanced spreading factor detection are described more fully below.

Because it is important to use information from the previous slots, buffering the previous slots is necessary. Further, in order to use the information from other stages, the signal from other stages must be input to the spreading factor detector. For that reason, as shown in FIG. 16, a selector 1606 having a buffer is provided before the spreading factor detector 800 (or 600), so that the information from previous slots and other stages can be utilized and any information needed among the stored information can be selected and input to the spreading factor detector.

In the descriptions below, the following notations are used:

aₓ=the first stage, slot x

bₓ=the second stage, slot x

cₓ=the third stage, slot x

SF(aₓ)=Spreading Factor for slot x of the first stage

SF(bₓ)=Spreading Factor for slot x of the second stage

SF(cₓ)=Spreading Factor for slot x of the third stage

Σ means that different slots are taken into account, but not that the spreading factors are added together.

The first method for determining the spreading factor for each slot of each stage, which is used when the stages are considered independently, is based on a cumulative determination based on previous slots. That is;

$$SF ( {a}_{x} ) = {\sum }_{i = 1}^{x} {a}_{i} for 1 \leq x \leq N$$

$$SF ( {b}_{x} ) = {\sum }_{i = 1}^{x} {b}_{i} for 1 \leq x \leq N$$

$$SF ( {c}_{x} ) = {\sum }_{i = 1}^{x} {c}_{i} for 1 \leq x \leq N$$

As an example, to estimate the spreading factor for slot “a₂”, slot “a₁” and slot “a₂” are used by the spreading factor detector. To estimate the spreading factor for slot “a₃”, slot “a₁”, “a₂” and “a₃” are used by the spreading factor detector.

This process then repeats itself for all the slots in the first stage, and is the same regardless of the stage, except, of course, that for different stages, the respective slots would be used.

The second method for providing enhanced spreading factor detector in a multi-stage receiver, when the stages are considered completely dependent, is to use information from all the stages to establish the spreading factor. That is;

$$SF ( {a}_{x} ) = \begin{matrix}{\sum }_{i = 1}^{x} {a}_{i} & x = 1 \\ {\sum }_{i = 1}^{x} {a}_{i} + {\sum }_{i = 1}^{x - 1} {b}_{i} & x = 2 \\ {\sum }_{i = 1}^{x} {a}_{i} + {\sum }_{i = 1}^{x - 1} {b}_{i} + {\sum }_{i = 1}^{x - 2} {c}_{i} & 3 \leq x \leq N\end{matrix}$$

$$SF ( {b}_{x} ) = \begin{matrix}{\sum }_{i = 1}^{x + 1} {a}_{i} + {\sum }_{i = 1}^{x} {b}_{i} & x = 1 \\ {\sum }_{i = 1}^{x + 1} {a}_{i} + {\sum }_{i = 1}^{x} {b}_{i} + {\sum }_{i = 1}^{x - 1} {c}_{i} & 2 \leq x \leq N - 1 \\ {\sum }_{i = 1}^{x} {a}_{i} + {\sum }_{i = 1}^{x} {b}_{i} + {\sum }_{i = 1}^{x - 1} {c}_{i} & x = N\end{matrix}$$

$$SF ( {c}_{x} ) = \begin{matrix}{\sum }_{i = 1}^{x + 2} {a}_{i} + {\sum }_{i = 1}^{x + 1} {b}_{i} + {\sum }_{i = 1}^{x} {c}_{i} & 1 \leq x \leq N - 2 \\ {\sum }_{i = 1}^{x + 1} {a}_{i} + {\sum }_{i = 1}^{x + 1} {b}_{i} + {\sum }_{i = 1}^{x} {c}_{i} & x = N - 1 \\ {\sum }_{i = 1}^{x} {a}_{i} + {\sum }_{i = 1}^{x} {b}_{i} + {\sum }_{i = 1}^{x} {c}_{i} & x = N\end{matrix}$$

As an example, to estimate the spreading factor for slot “a₁”, slot “a₁” is used by the spreading factor detector.

To estimate the spreading factor for slot “a₂” and “b₁”, slot “a₁”, “a₂”, and “b₂” are used by the spreading factor detector.

To estimate the spreading factor for slot “a₃”, “a₂” and “c₁”, slot “a₁”, “a₂”, “a₃”, “b₁”, “b₂” and “c₁” are used by the spreading factor detector. This process is then repeated for all slots in the frame.

The third method of providing enhanced spreading factor detection in a multi-stage receiver, when the stages are considered quasi-dependently, uses less than all the information from all stages. This is an intermediate solution, between the first and the second in complexity and precision, and reduces the complexity of calculating the spreading factor. The spreading factors are determined according to the following;

$$SF ( {a}_{x} ) = \begin{matrix}{\sum }_{i = 1}^{x} {a}_{i} & x = 1 \\ {\sum }_{i = 1}^{x} {a}_{i} + {\sum }_{i = 1}^{x - 1} {b}_{i} & 2 \leq x \leq N\end{matrix}$$

$$SF ( {b}_{x} ) = \begin{matrix}{\sum }_{i = 1}^{x + 1} {a}_{i} + {\sum }_{i = 1}^{x} {b}_{i} & 1 \leq x \leq N - 1 \\ {\sum }_{i = 1}^{x} {a}_{i} + {\sum }_{i = 1}^{x} {b}_{i} & x = N\end{matrix}$$

$$SF ( {c}_{x} ) = \begin{matrix}{\sum }_{i = 1}^{x + 2} {a}_{i} + {\sum }_{i = 1}^{x + 1} {b}_{i} & 1 \leq x \leq N - 2 \\ {\sum }_{i = 1}^{x + 1} {a}_{i} + {\sum }_{i = 1}^{x + 1} {b}_{i} & 1 \leq x \leq N - 1 \\ {\sum }_{i = 1}^{x} {a}_{i} + {\sum }_{i = 1}^{x} {b}_{i} & x = N\end{matrix}$$

As an example, to estimate the spreading factor for slot “a₁”, slot “a₁”, is used by the spreading factor detector.

To estimate the spreading factor for slots “a₂” and “b₁”, slot “a₁”, “a₂” and “b₁” are used by the spreading factor detector.

To estimate the spreading factor for slots “a₃”, “b₂” and “c₁”, slot “a₁”, “a₂”, “a₃”, “b₁” and “b₁” are used by the spreading factor detector. Note that “c₁” is not used here. This process then repeats itself.

The fourth method of providing enhanced spreading factor detection, when the stages are considered dependent of each other, but not utilizing the current slot, uses information from only previous slots to establish the spreading factor. This calculation is much less complex than the first second or third method, yet produces fairly good performance.

If the processing time must be kept to a minimum, it will not be acceptable to wait until the current slot is completely input. However, since this fourth method does not use the current slot, it is able to reduce the delay corresponding to one slot.

In the fourth method, the spreading factor are determined according to the following;

$$No blind SF detection \qquad x = 1$$

$$S F ( {a}_{x} ) = \begin{matrix}{\sum }_{i = 1}^{x - 1} {a}_{i} + {\sum }_{i = 1}^{x - 1} {b}_{i} & x = 2 \\ {\sum }_{i = 1}^{x - 1} {a}_{i} + {\sum }_{i = 1}^{x - 1} {b}_{i} + {\sum }_{i = 1}^{x - 2} {c}_{i} & 3 \leq x \leq N\end{matrix}$$

In this method, with regard to the slot “a₁” the spreading factor estimation process is not performed by the spreading factor detector. Instead, for example, the shortest spreading factor of the possible spreading factors is selected as a spreading factor for the slot “a₁” and then it is output from the spreading factor detector.

To estimate the spreading factor for slots “a₂”, slot “a₁” and “b₁” is used by the spreading factor detector.

To estimate the spreading factor for slots “a₃”, slot “a₁”, “a₂”, “b₁”, “b₂” and “c₁” is used by the spreading factor detector. This process then repeats itself for all slots.

For other stages, the spreading factor SF(aₓ) is used.

The amount of data used for the spreading factor estimation depends on the delay between the stages and other conditions. However, the above-described methods can estimate the spreading factor without waiting until the whole frame is received. Therefore, the above-described methods will substantially reduce the processing delay in a variable spreading factor CDMA system and make it feasible to implement interference cancellation receivers, which can increase the capacity, the range and/or lower the output power of the mobile terminals, in commercial systems.

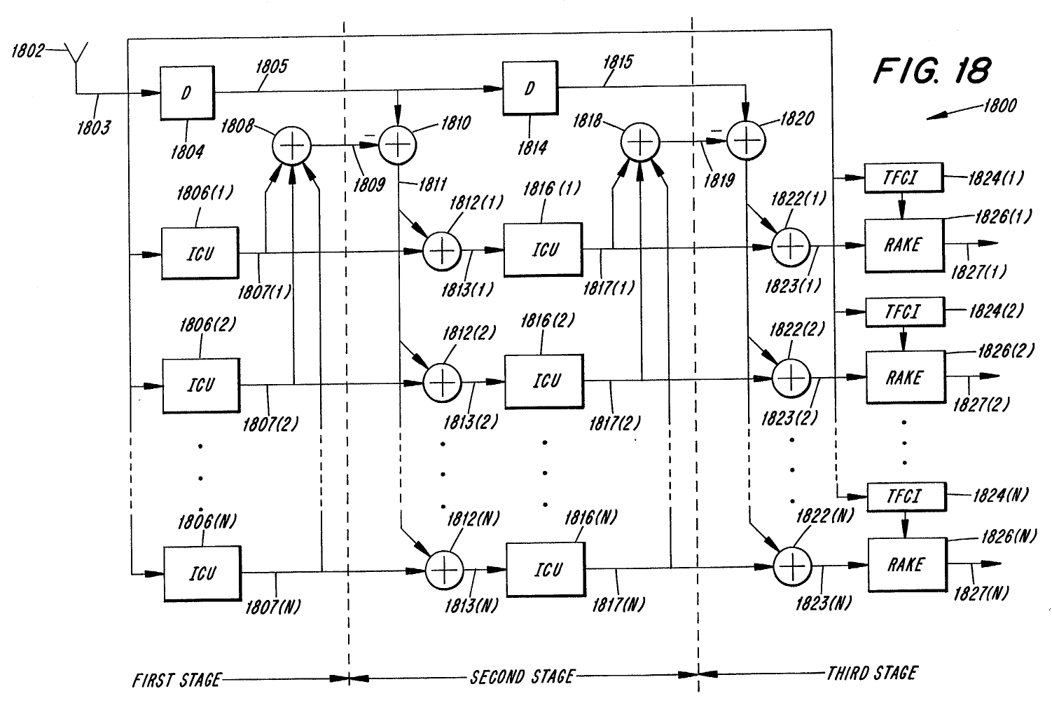

FIG. 18 illustrates a modified multi-stage interference cancellation receiver with a spreading factor detector of an embodiment of the invention. A W-CDMA receiver configuration exists in which it is acceptable to wait until an entire frame has been received prior to determining the spreading factor. In this W-CDMA receiver configuration, determination of the final estimated spreading factor 628 (or 828) is made on the basis of the TFCI bits of the control channel. FIG. 18 illustrates a modified multi-stage interference cancellation receiver 1800 which institutes determination of the non-zero rate spreading factor in a TFCI detector.

The difference between the modified multi-stage interference cancellation receiver of FIG. 18 and the unmodified version (FIG. 15) is the replacement in the third stage of the ICUs with RAKE receivers 1826, and the addition of TFCI detectors 1824, one for each RAKE receiver 1826. The input of each TFCI detector 1824 is connected directly to the baseband signal 1803 and the output of the TFCI detector 1824 is connected to a second input of the aforementioned RAKE receiver 1826.

Each TFCI detector 1824 determines a spreading factor on the basis of the TFCI bits of the control channel of each user. That is, each TFCI detector 1824 receives an entire frame and determines the spreading factor on the basis of the TFCI bits distributed within the frame. The spreading factor determined by each

SF(cₓ)=SF_{TFCIX} 1≦x≦N

As an example, to estimate the spreading factor for slot “a₁”, slot “a₁” is used by the spreading factor.

To estimate the spreading factor for slot “a₂”, slot “b₂” is used by the spreading factor detector.

To estimate the spreading factor for slot “a₃”, slot “b₁” and “b₂” are used by the spreading factor detector.

To estimate the spreading factor for slot “b₁” slot “b₁” is used by the spreading factor detector.

To estimate the spreading factor for slot “b₂”, slot “b₁” and “b₂” are used by the spreading factor detector.

To estimate the spreading factor for slot “b₃”, slot “b₁”, “b₂” and “b₃” are used by the spreading factor detector. This process is then repeated for all slots in the frame.

As described, the method for determining a non-zero rate spreading factor according to the modified multistage interference cancellation receiver 1800 requires a delay of one frame period (10 MS). Although this is a significant delay, when accurate symbol detection is desired this method is preferred. However, since the interference cancellation process has already been completed when the non-zero rate spreading factor is detected based on the TFCI bits, the receiver 1800 is able to start the final symbol detection process immediately after the spreading factor has been detected. Therefore, compared with starting the TFCI detector 1824(1)-(N) is output to its associated RAKE receiver 1826(1)-(N), respectively.

Each ICU 1806, 1816 of the first and second stage (respectively) has the spreading factor detector 800 (or 600) (as shown in FIG. 16). ICUs 1806 and 1816 perform the interference cancellation process using the final estimated spreading factor 628 (or 828) determined by the spreading factor detector 800 (or 600). The received signal of each user is input to the rake receivers 1826(1)-(N).

Each RAKE receiver 1826 contains a buffer of sufficient size to store at least one frame of the baseband W-CDMA signal 1803. TFCI detector 1824 determines the spreading factor of the control channel, and then outputs it to the RAKE receiver 1826. The RAKE receiver 1826, having stored an entire frame of received signal, then uses the TFCI generated spreading factor to perform a de-spreading process on the stored received signal. The detected symbols are then output as modified multi-stage interference cancellation receiver output signals 1827.

The spreading factor detector 800 (or 600) within each ICU estimate the final estimated spreading factor 628 (or 828) according to the following method:

$$S F ( {a}_{x} ) = \begin{matrix}{\sum }_{i = 1}^{x} {a}_{i} & x = 1 \\ {\sum }_{i = 1}^{x - 1} {b}_{i} & 2 \leq x \leq N\end{matrix}$$

$$S F ( {b}_{x} ) = \begin{matrix}{\sum }_{i = 1}^{x} {b}_{x} & 1 \leq x \leq N\end{matrix}$$

interference cancellation process after the spreading factor is detected based on the TFCI bits, this method can reduce the overall processing delay.

FIG. 19 illustrates an adaptive single user detector with a spreading factor detector of an embodiment of the invention. Single user detectors are well known in the art, and are considered a species of interference cancellation techniques. Interference cancellation techniques are proposed as one of the methods to reduce the cross-correlation from other users. There are at least two well known interference cancellation techniques. The first is a multi-user detector that demodulates not only the desired signal of the intended channel, but also the signals of other simultaneous users received at the receiver, using the spreading code information of the other users. The second is a single user detector that minimizes average cross-correlation and noise components from other simultaneous users, using the spreading code of only the intended channel. Among these, the single user detector corrects a spreading code such that the cross-correlation from other users produced in the process of de-spreading the desired user signal is reduced through quadrature filters in the receiver.

The adaptive single user detector 1900 of FIG. 19, contains the following components: a multiplier 1902, a symbol detector 1906, a spreading factor detector 800 (or 600) and a processing unit 1904. The processing unit 1904, contains a processor 1904A, a memory 1904B, an input/output port 1904C and a bus 1904D (the components of the processing unit 1904 are not shown) that connects all three components to each other. The processing unit 1904 uses the processor 1904A, bus 1904C and memory 1904B to perform the mathematical function of an adaptive algorithm.

The adaptive single user detector 1900 works in the following manner. The received signal (in vector notation) r(t), is de-spread by multiplication with a de-spreading vector wₖ^{H}(t) 1905 where t is a time index and k a user index, which is provided from the processing unit 1904. The multiplier output signal yₖ(t) 1903 from the multiplier 1902 is input to the symbol detector 1906. The symbol detector 1906 detects received symbols on the basis of the multiplier output signal yₖ(t) 1903, and outputs the detected symbols bₖ(t) 1907. The signal yₖ(t) 1903 and bₖ(t) 1907 are also input to the processing unit 1904.

The processing unit 1904 generates the spreading code vector corresponding to the final estimated spreading factor 628 (or 828) determined by the spreading factor detector 800 (or 600) and updates the spreading code vector based on the signal r(t) 1901, yₖ(t) 1903 and bₖ(t) 1907, so that interference signals will be orthogonal to the desired user signal. The predetermined adaptive algorithm, e.g., a Least Mean Squares (LMS) algorithm, is used as an algorithm for updating the spreading code vector Wₖ^{H}(t) 1905. By de-spreading the received signal with the updated spreading code vector wₖ^{H}(t) 1905, the adaptive single user detector 1900, is able to maximize the SIR of the desired user. Thus, the adaptive single user detector 1900 performs the demodulating process by reducing the influence of interference signals.

FIG. 20 illustrates a large buffer interference cancellation receiver with a spreading factor detector of an embodiment of the invention. The large buffer interference cancellation receiver 2000 is an exemplary use of the spreading factor detector 800 (or 600). In the case of a variable spreading factor system, interference cancellation receivers need to know the correct spreading factor before starting interference cancellation. If it is very important to cancel as much interference as possible, the interference cancellation process using a reliable spreading factor should be performed from the start of the frame. This can be achieved by buffering the received signal for a time equal to the time the spreading factor detector needs to detect the reliable spreading factor.

The large buffer interference cancellation receiver 2000 has a large data buffer 2004 in parallel with a spreading factor detector 800 (or 600). The input to both the large data buffer 2004 and spreading factor detector 800 (or 600) is output of antenna 2002. The output of the spreading factor detector 800 (or 600) and the output of the large data buffer 2004 are both connected to inputs of the subtractive multi-stage interference cancellation receiver 1500. The output of the subtractive multi-stage interference cancellation receiver 1500 is connected to a de-interleaver channel decoder 2006.

The large data buffer 2004 buffers the received signal 2001 for the time that the spreading factor detector 800 (or 600) needs for detection of the spreading factor. The spreading factor detector 800 (or 600) detects the spreading factor based on the received signal 2001. When the final estimated spreading factor 628 or 828) is determined by the spreading factor detector data is read out from the large data buffer 2004 and then the interference cancellation and symbol detection process is performed with the spreading code corresponding to the determined final estimated spreading factor 628 (or 828). In this case, the buffer length corresponds to the processing time that the spreading factor detector 800 (or 600) uses in determining the final estimated spreading factor 628 (or 828). Because the large buffer interference cancellation receiver 2200 performs the interference cancellation process with a reliable spreading factor from the start of the frame, it is possible to perform more accurate data detection.

FIG. 21 illustrates a parallel interference cancellation receiver with a spreading factor detector of an embodiment of the invention. The parallel interference cancellation receiver 2100 cancels as much interference as possible without delaying processing. The parallel interference cancellation receiver 2100 is comprised of an antenna 2102, the output of which is connected to a conventional receiver 2104 and the subtractive multi-stage interference cancellation receiver 1500 with the spreading factor detector 800 (or 600). The output of the subtractive multi-stage interference cancellation receiver 1500 and the conventional receiver 2104 are connected to separate inputs of a selector 2106. The output of the selector 2106 is connected to an input of a de-interleaver channel decoder 2108.

The parallel interference cancellation receiver 2100 cancels as much interference as possible without delaying the processing of data. The parallel interference cancellation receiver 2100 does this by using parallel receivers. In the parallel interference cancellation receiver 2100 there is no large data buffer before the subtractive multi-stage interference cancellation receiver 1500. Instead, a conventional receiver 2104 runs in parallel with the subtractive multi-stage interference cancellation receiver 1500. In the conventional receiver 2104, there is no knowledge of the spreading factor. Instead, the conventional receiver 2104 de-spreads the received signal with the spreading code corresponding to the shortest spreading factor of the possible spreading factors, utilizing channel compensation and RAKE combining. It is therefore possible to use the result from the conventional receiver 2104 as backup for the subtractive multi-stage interference cancellation receiver 1500 as an input to the de-interleaver channel de-coder 2108.

The parallel interference cancellation receiver 2100 works in the following manner. The conventional receiver 2104 de-spreads the received signal with the spreading code corresponding to the shortest spreading factor of the possible spreading factors, and then detects the received symbols. The subtractive multi-stage interference cancellation receiver 1500 has the spreading factor detector 800 (or 600), and performs the interference cancellation process and the symbol detection process using the final estimated spreading factor 628 (or 828) determined by the spreading factor detector 800 (or 600), from the start of the frame.

The control unit of the parallel interference cancellation receiver 2100 (not shown) determines whether or not the incorrect spreading factor was determined by the spreading factor detector 800 (or 600) (i.e., whether or not the interference cancellation and symbol detection process was performed with the incorrect spreading factor). This determination is then sent to the selector 2106. This determination is made by the control unit detecting TFCI bits from the control channel, determining the correct spreading factor on the basis of the TFCI bits, and comparing the control unit's determined spreading factor against the estimated spreading factor determined by the spreading factor detector 800 (or 600). When the determination is such that the wrong spreading factor was used in the spreading factor detector 800 (or 600), the selector 2106 selects the output of the conventional receiver 2104 and replaces the incorrect data (data generated by the subtractive multistage interference cancellation receiver 1500 with the incorrect spreading factor) with “good” data from the conventional receiver 2104. Since the data from the conventional receiver 2104 has been processed with the shortest possible spreading factor, the data from the conventional receiver 2104 is transformed into the data corresponding to the correct spreading factor before the replacing process.

The parallel interference cancellation receiver 2100 is thus able to avoid using incorrect data and cancels as much interference as possible from the start of the frame without delaying processing. It is able to do this by using the data from the conventional receiver 2304 as backup for the subtractive multi-stage interference cancellation receiver 1400.

FIG. 22 illustrates a buffer parallel interference cancellation receiver with a spreading factor detector of an embodiment of the invention. The buffer parallel interference cancellation receiver 2200 cancels as much interference as possible without delaying processing.

The buffer parallel interference cancellation receiver 2200 is comprised of an antenna 2202, connected to the inputs of a conventional receiver 2204, spreading factor detector 800 (or 600) and large data buffer 2204. The outputs of the spreading factor detector 800 (or 600) and large data buffer 2204 are connected to separate inputs of the subtractive multi-stage interference cancellation receiver 1500. The outputs of the conventional receiver 2204 and the subtractive multi-stage interference cancellation receiver 1500 are connected to separate inputs of selector 2208, which can select between the two inputs, to provide an output signal connected to de-interleaver channel decoder 2208. Additionally, there is a processing unit (not shown) which contains a processor, memory, communications bus, and an input/output port.

The buffer parallel interference cancellation receiver 2200 works in the following manner. The spreading factor detector 800 (or 600) determines the final estimated spreading factor 828 (or 628) based on the baseband signal 2203. When a reliable spreading factor is detected by the spreading factor detector 800 (or 600), the buffered data is read out from the buffer 2206 and the interference cancellation process is performed in the subtractive multistage interference cancellation receiver 1500, with the spreading code corresponding to the final estimated spreading factor 828 (or 628).

Further, the conventional receiver 2204 de-spreads the received signal 2203 with the spreading code corresponding to the shortest spreading factor of the possible spreading factors. Both outputs of the conventional receiver 2204 and the subtractive multi-stage interference cancellation receiver 1500 are input to the selector 2208.

The processing unit of the buffer parallel interference cancellation receiver 2200 (not shown) determines whether or not the incorrect spreading factor was detected by the spreading factor detector 800 (or 600). This determination is then sent to the selector 2208. The determination is made for the same aforementioned reasons and in the same aforementioned manner, as was discussed with respect to the control unit of FIG. 21. The selector 2208 then selects the output of the conventional receiver 2204 and replaces the incorrect data (data generated by the subtractive multistage interference cancellation receiver 1500 when an incorrect spreading factor was used) with “good” data from the conventional receiver 2204.

The buffer parallel interference cancellation receiver 2200 is thus able to perform more accurate data detection since the interference cancellation process is performed with a reliable spreading factor from the start of the frame. Further, even if the interference cancellation and symbol detection process was performed with the wrong spreading factor at the subtractive multi-stage interference cancellation receiver 1500, it is possible to use the output of the conventional receiver 2204, thereby avoiding incorrect data detection.

The embodiments described above are merely given as examples and it should be understood that the invention is not limited thereto. It is of course possible to embody the invention in specific forms other than those described without departing from the spirit of the invention. Further modifications and improvements which retain the basic underlying principles disclosed and claimed herein, are within the spirit and scope of this invention.

1. A method for estimating a spreading factor in a receiver of a variable spreading factor CDMA system, comprising:
inputting a received signal into a plurality of matched filters, each matched filter having a unique spreading factor, de-spreading the received signal with a spreading code corresponding to the spreading factor and outputting a plurality of de-spread signals;
calculating a mean power for each of the plurality of output de-spread signals; and
estimating a spreading factor of the received signal based on the calculated mean power.

2. The method according to claim 1, wherein the step of estimating a spreading factor of the received signal based on the calculated mean power, comprises:
determining a maximum mean power, and
finding the matched filter that corresponds to the maximum mean power; and
outputting the spreading factor of the matched filter that corresponds to the maximum mean power as the estimated spreading factor.

3. A method for estimating a spreading factor in a receiver of a variable spreading factor CDMA system, comprising:
inputting a received signal into a plurality of matched filters, each matched filter having a unique spreading factor and de-spreading the received signal with a spreading code corresponding to the spreading factor, and outputting a plurality of de-spread signals;
calculating an absolute amplitude for each of the plurality of de-spread signals;
calculating a matched filter integrand, MFAI_{X}, for each of the plurality of de-spread signals;
calculating a matched filter difference, MFD_{X}, for each pair of adjacent matched filters; and
estimating a spreading factor of the received signal based on the matched filter difference, MFD_{X}.

4. The method according to claim 3, wherein the step of calculating a matched filter integrand for each of the plurality of matched filters comprises:
integrating the absolute amplitude of the output of each of the plurality of matched filters as a function of time, for the time period equal to an estimation period.

5. The method according to claim 3, wherein the step of calculating the matched filter difference, MFD_{X} comprises:
computing
MFDₓ=|MFAIₓ−MFAIₓ₊₁| for x≧1.

6. The method according to claim 3, wherein the step of estimating a spreading factor of the received signal based on the matched filter difference, MFD_{X}, comprises:
determining which matched filter difference is the maximum; and
finding the matched filter that corresponds to the maximum matched filter difference; and
outputting the spreading factor of the matched filter that corresponds to the maximum matched filter difference as the estimated spreading factor.

7. A method for determining whether a zero rate transmission has occurred in a wide band code division multiple access communications system, comprising:
calculating a first threshold value;
calculating a likelihood ratio;
comparing the first threshold value to the likelihood ratio; and
determining a non-zero rate transmission has occurred if the likelihood ratio is greater than or equal to the first threshold value, or determining that a zero rate transmission has occurred if the likelihood ratio is less than the first threshold value.

8. The method of claim 7, wherein the step of calculating the first threshold factor comprises:
calculating the ratio of the probability that no data transmission has occurred to the probability that data transmission has occurred.

9. The method of claim 7, wherein the step of calculating the likelihood ratio comprises:
calculating the ratio of the value of the probability density function of a data transmission occurring at the value of r to the value of the probability density function of no data transmission occurring at the value of r.

10. The method of claim 8, wherein the step of calculating the ratio of the probability that no data transmission has occurred to the probability that data transmission has occurred comprises:
setting the probability that no data transmission has occurred to a first fixed value;
setting the probability that data transmission has occurred to a second fixed value; and
calculating the ratio of the first fixed value to the second fixed value as the first threshold factor.

11. The method of claim 8, wherein the step of calculating the ratio of the probability that no data transmission has occurred to the probability that data transmission has occurred comprises:
setting the probability that no data transmission has occurred to a third value determined empirically;
setting the probability that data transmission has occurred to a fourth value determined empirically; and
calculating the ratio of the third fixed value to the fourth fixed value as the first threshold factor.

12. A method for determining whether a zero rate transmission has occurred in a wide band code division multiple access communications system, comprising:
calculating a second threshold value, λ₂;
calculating a first test statistic, T₁(r);
comparing the second threshold value to the first test statistic; and
determining a non-zero rate transmission has occurred if the first test statistic is greater than or equal to the second threshold value, or determining that a zero rate transmission has occurred if the first test statistic is less than the second threshold value.

13. The method of claim 12, wherein the step of calculating the second threshold factor comprises:
calculating a first threshold factor, λ; and
calculating the second threshold factor, λ₂, according to the following equation:
$${λ}_{2} = \frac{[ ln λ - \frac{N}{2} ln ( \frac{{σ}_{o}^{2}}{{σ}_{s}^{2} + {σ}_{o}^{2}} ) ]}{[ \frac{{σ}_{s}^{2}}{2 {σ}_{o}^{2} ( {σ}_{s}^{2} + {σ}_{o}^{2} )} ]}$$

14. The method of claim 12, wherein the step of calculating the first test statistic, T₁(r), comprises:
calculating the first test statistic, T₁(r), according to the following equation:
$${T}_{1} ( r ) = {\sum }_{n = 0}^{N - 1} {r}^{2} [ n ]$$

15. The method of claim 12, wherein the step of calculating the second threshold factor, λ₂, comprises:
determining an interference strength signal I, a signal to interference ratio signal SIR, and a first threshold factor λ; and
calculating the second threshold factor, λ₂, according to the following equation:
$${λ}_{2} = \frac{2 I ( S I R + 1 )}{S I R} [ ln λ - \frac{N}{2} ln ( \frac{1}{S I R + 1} ) ]$$

16. The method of claim 12, wherein the step of wherein the step of calculating the first test statistic, T₁(r), comprises:
equating the first test statistic, T₁(r), to an energy signal E_{XM}, determined from the outputs of a plurality of matched filters of the wide band code division multiple access receiver.

17. A method for determining whether a zero rate transmission has occurred in a wide band code division multiple access communications system, comprising:
calculating a third threshold value, λ₃;
calculating a second test statistic, T₂(r);
comparing the third threshold value to the second test statistic; and
determining a non-zero rate transmission has occurred if the second test statistic is greater than or equal to the third threshold value, or determining that a zero rate transmission has occurred if the second test statistic is less than the third threshold value.

18. The method of claim 17, wherein the step of calculating the third threshold factor comprises:
calculating the third threshold factor, λ₃, according to the following equation:
$${λ}_{3} = {Q}_{{R}_{v}^{{2}^{- 1}}} ( {P}_{FA} )$$

19. The method of claim 17, wherein the step of calculating the second test statistic, T₂(r), comprises:
calculating the second test statistic, T₂(r), according to the following equation:
$${T}_{2} ( r ) = \frac{{\sum }_{n = 0}^{N - 1} {r}^{2} [ n ]}{{σ}_{o}^{2}}$$

20. The method of claim 17, wherein the step of wherein the step of calculating the second test statistic, T₂(r), comprises:
determining an energy signal, E_{XM}, of an output of a plurality of matched filters of the wide band code division multiple access receiver, and an interference strength signal, I; and
calculating the ratio of the energy signal E_{XM} to the interference strength signal I, as the second test statistic, T₂(r).

21. A spreading factor detector, for use in a wideband code division multiple access communications system, comprising:
a de-scrambler, with an input connected to a received baseband signal, and a real signal output, and an imaginary signal output;
a SIR processor, with an input connected to the imaginary signal output, and a plurality of SIR processor outputs;
a plurality of matched filters, each matched filter having an input connected to the real signal output, and a matched filter output;
a non-zero rate spreading factor detector having a plurality of inputs connected to the plurality of matched filter outputs, and a plurality of non-zero rate spreading factor detector outputs; and
a zero rate spreading factor detector having a plurality of inputs connected to the plurality of non-zero rate spreading factor detector outputs and the plurality of SIR processor outputs, and an estimated spreading factor output signal.
